(19) United States
(12) Patent Application Publication
(10) Pub. No.: US 2006/0277060 A1
(43) Pub. Date: Dec. 7, 2006

(54) Dynamic authoring of transaction display

(76) Inventor: Walter Gerard Antognini, New York, NY (US)

Correspondence Address: Prof. Walter Antognini, One Pace Plaza Office W485, New York, NY, 10038, US

(21) Appl. No.: 11/418,487

(22) Filed: May 4, 2006

Related U.S. Application Data
(60) Provisional application No. 60/678,103, filed on May 5, 2005.

(51) Int. Cl. G06F 17/00; G06Q 99/00

(52) U.S. Cl. 705/1; 715/500; 715/730

(57) ABSTRACT

A method of parsing plain language descriptions of business transactions and creating diagrams therefrom. A user describes a transaction in language that is structured yet flexible and clearly understandable by practitioners. The method parses this language, identifies components to display, creates parameters for the diagram to display these components, creates a file containing the diagram and displays the diagram.

### CROSS-REFERENCE TO RELATED APPLICATIONS

This application claims the priority of a provisional application Ser. No. 60/678,103, Dynamic Authoring of Transaction Display, filed May 5, 2005.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND OF THE INVENTION

The invention generally relates to a method to automatically (i.e., without human intervention) create a diagram or diagrams of a business transaction or transactions. The invention does not comprehend the business transactions or hypothetical transactions themselves. Instead the invention has as its primary purpose the facilitation of describing transactions that would occur in the business world.

While the preferred embodiments are described largely by reference to transactions that raise or describe income tax considerations, it should be understood that the invention is not so limited and can be used to facilitate the description of any transaction, including those raising a particular tax issue or issues, those that raise other legal issues (e.g., issues of corporate law or bankruptcy), those that raise business issues or simply illustrate business transactions or even events that have no business purpose. For example, the invention could be used to illustrate how notes were passed among students in a classroom. Also, in a courtroom setting, for example, trial attorneys could use the invention to create diagrams of how weapons or other licit or illicit items were passed among members of a criminal organization. With modifications within the capacity of those skilled in the art, the invention could enjoy further use as a means of describing sports plays, including football and basketball plays.

By far, the most common method used for describing business and, particularly, tax-related transactions today is through textual description. The ability of readers, the users of these descriptions, to comprehend the transaction decreases as the transactions become more complicated. Textual description has the advantage of providing precision, an element of significant importance in legal matters. And yet, as the transactions become more complicated, a mere textual description, while precise, diminishes in its ability to convey comprehension. It is understood in other areas that the use of multimedia techniques such as graphics, animation and audio, enhances comprehension.

The use of these techniques can have a significant impact on the comprehension of business and/or tax-related transactions. And yet, these techniques are not widely used. A lack of adequate tools presents a significant obstacle in the widespread adoption of such multimedia techniques for conveying transaction descriptions. Some tools are available. For example, Microsoft PowerPoint, by Microsoft of Redmond, Wash., a presentation software application, could be used to create and display transaction diagrams. The PowerPoint application allows for the creation and placement of shapes, text, arrows, audio and even animation. All of these components can prove quite useful in the process of developing a multimedia description of a transaction.

And yet, while PowerPoint could be quite useful for the development of multimedia descriptions of transactions, use of that application presents significant limitations. One major limitation is the need to manually develop a new diagram (a new slide) for each transaction, manually creating shapes, text, arrows, etc. and manually placing those components into a slide. While a person might with practice become somewhat adept at developing these slides, the process would nonetheless remain a labor-intensive exercise. If the person engaged in the development process is a tax practitioner, that labor comes at a high cost. If the person engaged in the development process is not a tax practitioner but is instead skilled in the art or developing such diagrams, this practice would require significant involvement from tax practitioners. The limited number of devices capable of using PowerPoint presents another major obstacle to the use of PowerPoint for the purposes indicated.

What is needed then, is a process for automating the development of multimedia displays of transactions.

### BRIEF SUMMARY OF THE INVENTION

In order to address the needs described above, the invention discloses a process to automate the creation of diagrams intended to describe transactions. This process would include the various elements of graphics, animation, text and audio, but mostly graphics, animation and text.

The process begins by a person, such as a tax practitioner, determining transactions that require a diagram. The practitioner or other person then creates a text description of each transaction, preferably using indicated protocols that, while restricting somewhat the manner of describing transactions, would nonetheless be easily comprehended by this or other practitioners. The process would parse the textual description so as to derive facts relevant to creation of a diagram.

The process would identify the components of the transaction from the parsed description.

These components would include the persons indicated (name and type), the actions between those persons, attributes of those persons, a title for the diagram, and any further textual information that the user wishes to convey in the diagram.

The process would, based on the information provided, derive chains or a web of ownership suggested by the facts. The process accomplishes this by identifying the ownerships indicated by the facts (ownerships either in stock or in debt), creating tiers of ownership by applying an iterative process of identifying the top owner indicated and then creating further tiers based on what owners in higher tiers own, and then creating chains of ownership through a combination of identifying any top-level ownership interests that do not overlap and then stacking the persons based on their tier. Different chains of ownership are separated from each other horizontally. Through this process, the invention establishes a row and column for each person in the web indicated by the description.

The process then derives a pixel position (horizontal and vertical) for each person. The process derives a pixel position primarily based on a person's row and column, but also through certain adjustments, such as moving all persons down in order to make room for a title.

The process derives the parameters of each component of the diagram from the information parsed from the description and from the pixel positions of persons previously derived. For example, the pixel positions for the display of a transfer between persons would be derived based largely on the pixel positions of those persons. The preferred embodiment creates a text file containing those parameters.

The process then creates a presentation file from the parameters. This presentation file would include the diagram, any animation created by the process, and any audio added to the diagram. If so indicated by the person creating the diagram description text file, the process would animate any actions between persons by causing the presentation file to gradually move text and/or a graphic image along a theoretical line represented by the pixel positions of an action between persons, as derived based on the previous discussion. The presentation file would include a diagram for each transaction indicated in the diagram description text file.

The diagram presentation file having thus been created, a user could then activate the presentation based on well-known methods or based on methods disclosed by the invention. Other aspects disclosed address the printing of digital data on paper where the digital data printed either contains a signal as to which diagrams to display, data from which the diagrams can be created, and/or the diagrams themselves. Still further aspects of the disclosed invention address the devices for decoding the printed digital data and for displaying the diagrams.

Other aspects of the invention will become apparent to those skilled in the art from the complete description provided.

### BRIEF DESCRIPTION OF THE DRAWINGS

The present invention will be understood more fully from the detailed description given below and from the accompanying drawings of the preferred embodiments of the invention which, however, should not be taken to limit the invention to the specific embodiments, but are for explanation and understanding only.

FIG. 1 is a block diagram describing the overall process for authoring diagrams of transactions.

FIG. 2 is a plain English description of a series of scenarios (transactions) from which diagrams can be created by the use of the invention

FIG. 3 is an example of a diagram description text file based on the plain English description of a series of scenarios, such description being that from FIG. 2. This file is created by the user and then processed by the invention to create a diagram parameter text file and, ultimately, the diagrams of the transactions contained therein.

FIG. 4 is one of the series of entries in the diagram description text file from FIG. 3, such entry representing one transaction from which the invention will create one diagram.

FIG. 5 is one of a series of lines in the entry from FIG. 4 and thus represents one of a series of lines from an entry describing one transaction.

FIG. 6 is a block diagram describing the process by which the invention parses and converts a diagram description text file into a diagram parameter text file.

FIG. 7 is a block diagram elaborating on one step of the process of parsing and converting a diagram description text file into a diagram parameter text file, that step being the step of parsing each phrase.

FIG. 8 is a block diagram elaborating on one other step of the process of parsing and converting a diagram description text file into a diagram parameter text file, that step being the step of assigning a row and column to each person indicated by the description.

FIG. 9 is an example of a diagram parameter text file, which file would result from a diagram description text file containing one transaction.

FIG. 10 is a block diagram describing the process by which the invention converts a diagram parameter text file into a diagram presentation file.

FIG. 11 is an example of a printed diagram created by the invention, that diagram being what the preferred embodiment would create from description 301 which in turn was derived from scenario 201.

FIG. 12 is an example of a printed diagram created by the invention, that diagram being what the preferred embodiment would create from description 302 which in turn was derived from scenario 202.

FIG. 13 is an example of a printed diagram created by the invention, that diagram being what the preferred embodiment would create from description 303 which in turn was derived from scenario 203.

FIG. 14 is an example of a printed diagram created by the invention, that diagram being what the preferred embodiment would create from description 304 which in turn was derived from scenario 204.

FIG. 15 is an example of a printed diagram created by the invention, that diagram being what the preferred embodiment would create from description 305 which in turn was derived from scenario 205.

FIG. 16 is an example of a printed diagram created by the invention, that diagram being what the preferred embodiment would create from description 306 which in turn was derived from scenario 206.

FIG. 17 is an example of a printed diagram created by the invention, that diagram being what the preferred embodiment would create from description 307 which in turn was derived from scenario 207.

FIG. 18 is an example of a printed diagram created by the invention, that diagram being what the preferred embodiment would create from description 308 which in turn was derived from scenario 208.

FIG. 19 is an example of a printed diagram created by the invention, that diagram being what the preferred embodiment would create from a modified version of description 301 which in turn would have been derived from scenario 201.

FIG. 20 is an example of a printed diagram created by the invention, that diagram being what the preferred embodiment would create from a modified version of description 303 which in turn would have been derived from scenario 203.

FIG. 21 is a sheet which might be distributed to students in a corporate tax course which contains plain English description of a series of scenarios (transactions) from which diagrams can be created by the use of the invention, together with machine readable code containing the diagram description text file produced from that description.

FIG. 22 is an example of a printed diagram created by the invention, together with machine readable code containing the diagram description text file produced from a description that would produce an animated version of the diagram that is printed.

### DETAILED DESCRIPTION OF THE INVENTION

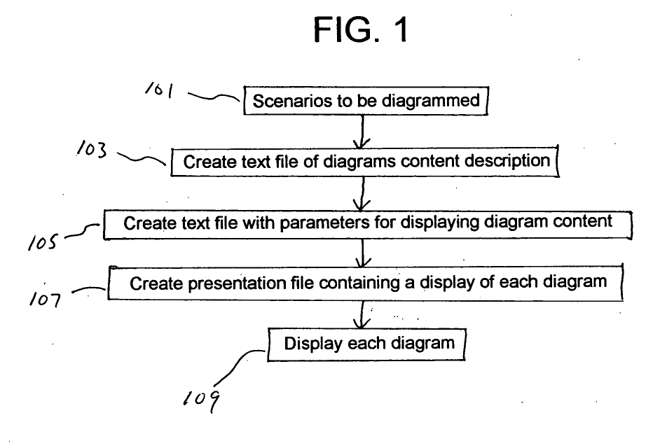

The overall method of the preferred embodiment of the present invention is described by reference to FIG. 1.

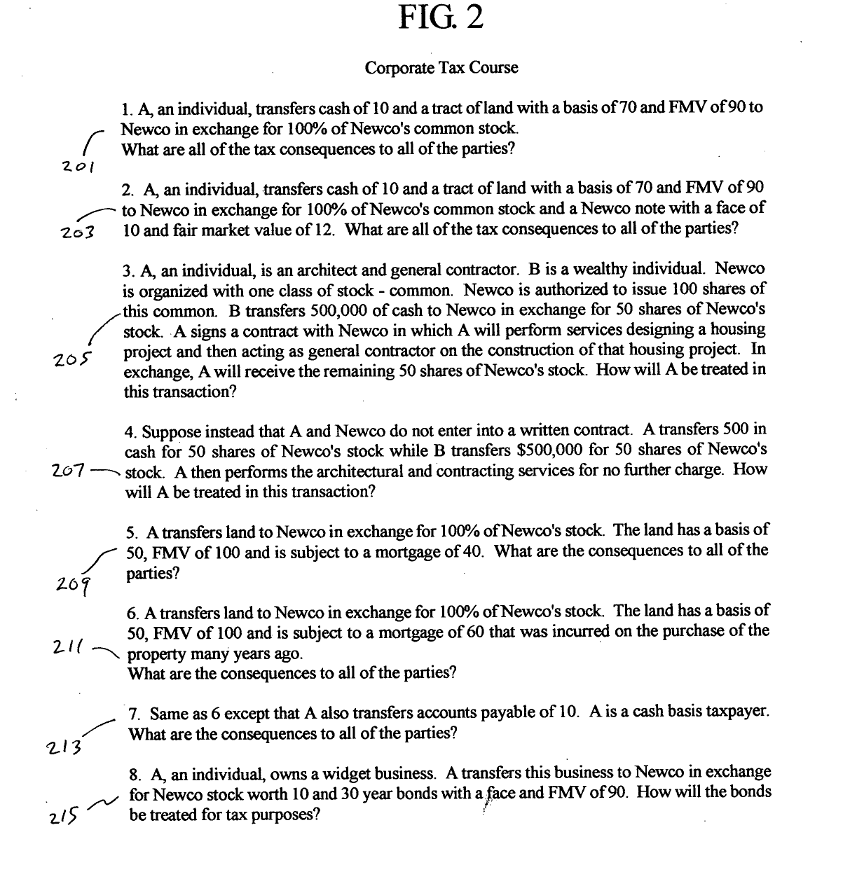

The user starts with one or more scenarios intended to be diagrammed, step 101. In the preferred embodiment, these scenarios are intended to illustrate the U.S. federal tax consequences of a series of facts, where that series of facts is intended as an example of a rule or rules of tax law. Those rules could come from, for example, the Internal Revenue Code, the Income Tax Regulations, rulings (e.g., revenue or private) or materials designed to instruct others on the federal tax law. The preferred embodiment is described by reference to scenarios from teaching materials for a course for teaching corporate taxation, these scenarios being as described in FIG. 2. The scenarios are preferably developed by an expert in the field of taxation.

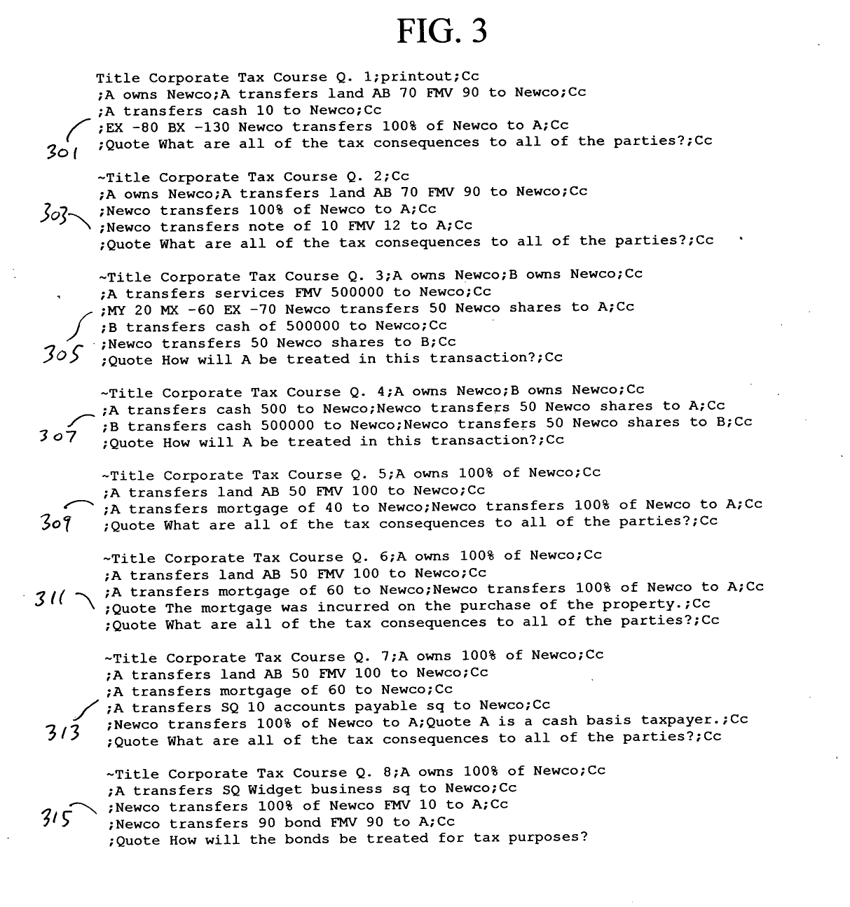

In step 103, the user then creates a text file containing descriptions of the diagrams intended to illustrate the scenarios produced in step 101. This text file in step 103, unlike the scenarios from step 101, is intended to follow a protocol used to facilitate sufficient automatic understanding so as to minimize, if not completely eliminate, further human input to create the displays of the intended diagrams. FIG. 3, described more fully below, provides an example of such a diagram description text file.

It should be understood that in the preferred embodiment steps 101 and 103 are produced manually by an expert in the field of knowledge from which the scenarios relate, such as the tax field. In other embodiments, the transition from step 101 to 103 is performed automatically by natural language parsers. In other embodiments a natural language parser could be used to skip step 103 altogether.

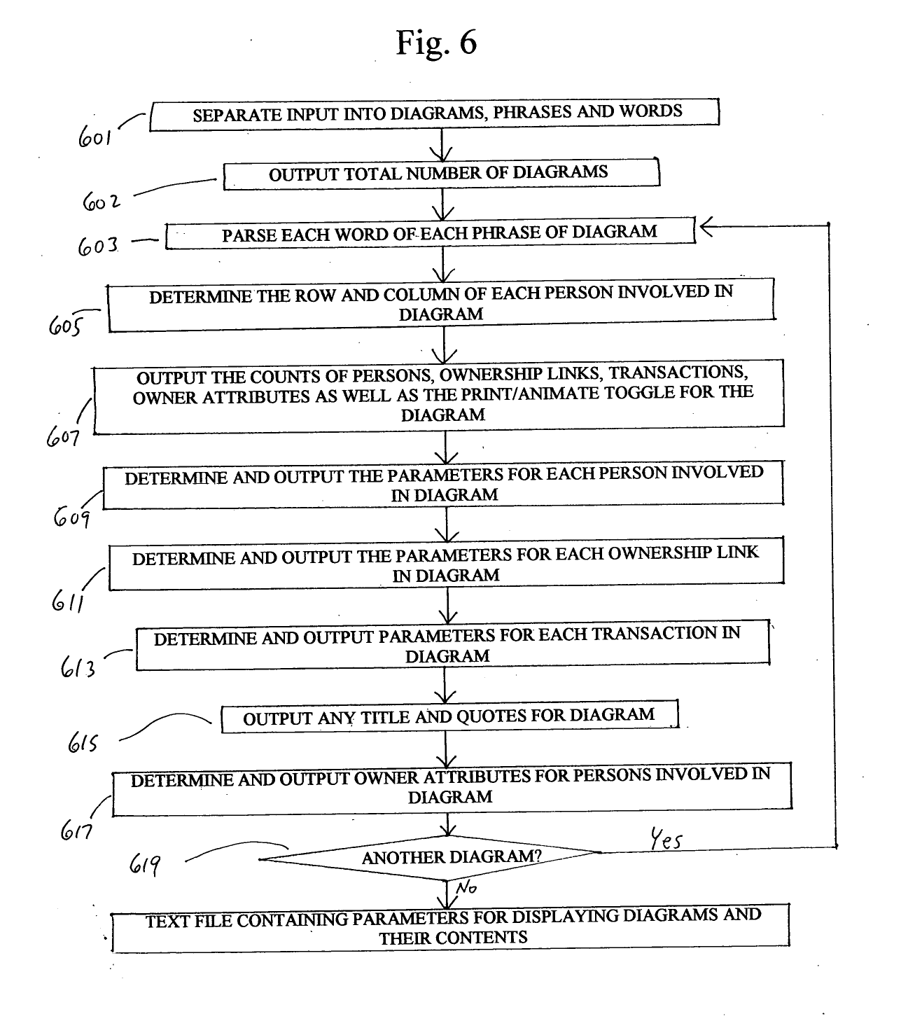

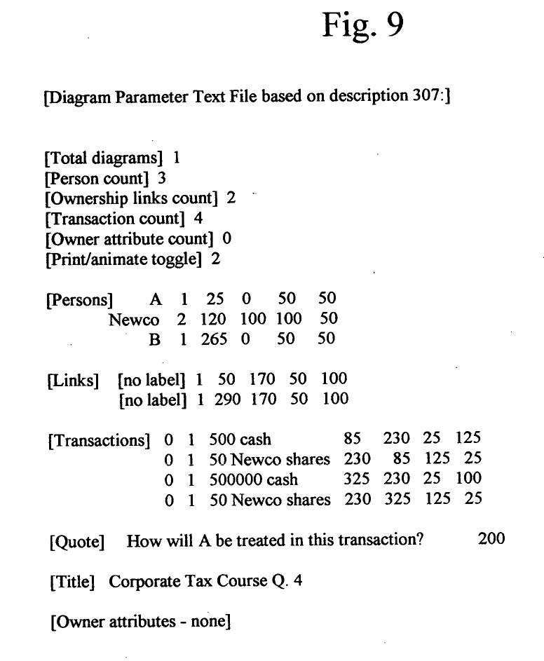

In step 105, a text file is created containing the parameters for displaying the diagram or diagrams described in the diagram description text file from step 103. The parameters contained in the file would include the number of diagrams and then, for each diagram, the number of persons in the diagram, the number of ownership (and/or debtor/creditor) links, the number of transactions, the number of owner attributes, a print/animate toggle, and then the parameters for any such persons, ownership links, transactions, owner attributes, titles and quotes. These detailed attributes are described more fully below by reference to FIG. 6, and an example of the contents of such a diagram parameter text file is provided in FIG. 9. Unlike the scenarios descriptions from step 101 and diagram description text file from step 103, this diagram parameter text file created in step 105 is preferably created automatically based on the data contained in the diagram description text file from step 103. In other embodiments, some or all of the parameters in the diagram parameter text file may be manually overridden or otherwise entered manually. The method of producing the diagram parameter text file in this step 105 is described by reference to FIG. 6.

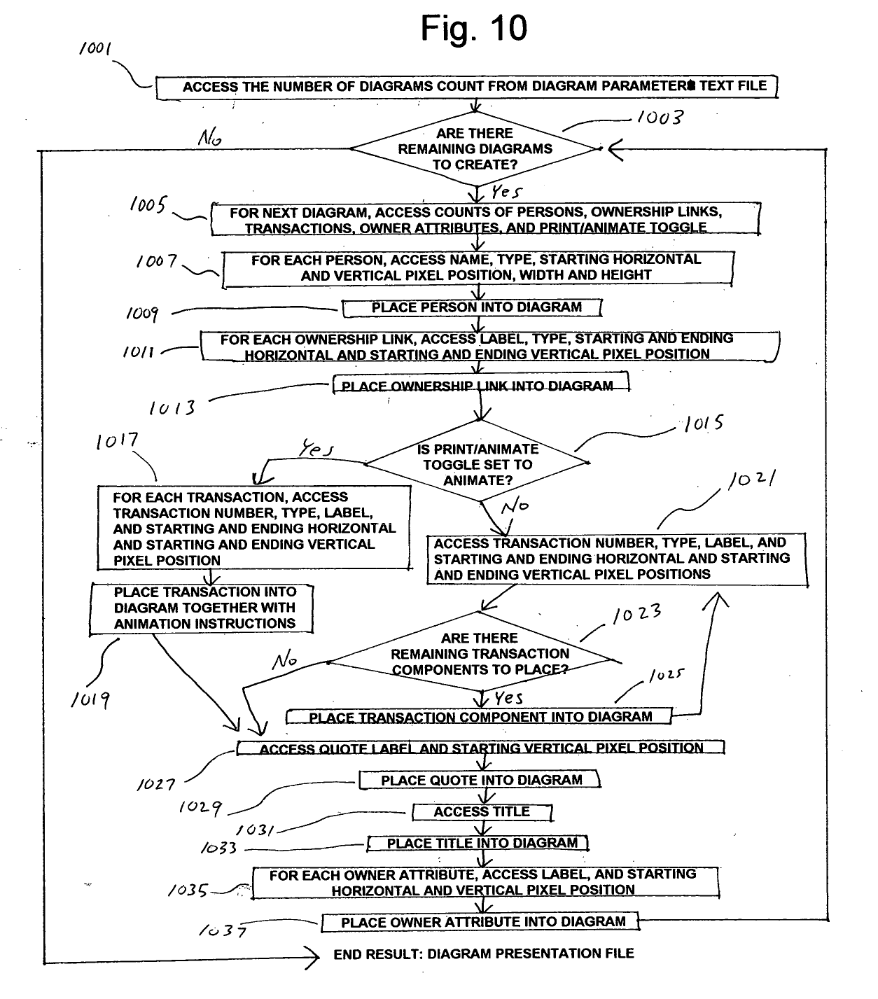

The next step, step 107, consists of converting the diagram parameter text file into a diagram presentation file. In the preferred embodiment, this conversion is automatically performed by a method described by reference to FIG. 10.

The results produced by step 107 will be a file containing one or more diagrams to be displayed. The final step, then, is to display those diagrams produced. In the preferred embodiment, the user has a choice of displaying the diagrams using animation, presumably one at a time, or printing out one or more of the diagrams. In the preferred embodiment, the default choice is to produce animation while the choice to produce diagrams suitable for printing is made by inserting an appropriate instruction in the diagram description text file. In the preferred embodiment, the person seeking to display the diagrams does so by manually invoking the appropriate software package (such as PowerPoint), and then loading the diagram presentation file (e.g., a PowerPoint file) and then either printing all of the diagrams (slides) or manually proceeding through each diagram.

In other embodiments, the invention displays diagrams produced from the diagram parameter text file through software written in C or another language, where that software interprets the parameters provided and produces the diagram, animated or static, from those parameters. The approach of using specially written display software instead of prepackaged software, such as PowerPoint, becomes especially important in contexts where PowerPoint is not available or not available in its full form. For example, use of the invention on personal digital assistants or cellphones would at present benefit from this specially written software. Use of these devices allows the tax professional to carry the diagrams away from a personal computer and to therefore access such diagrams more conveniently under a greater variety of circumstances. Use of these devices would typically suggest that some software be preloaded onto the device. Except for uses where the devices would dynamically download data, such as through machine readable code, described below, or through wireless access, the software preloaded would include the diagram presentation file itself or the steps of the invention to produce the diagram presentation file from data that is also preloaded.

FIG. 2 represents a typical set of scenarios which can benefit from the present invention. These scenarios are typical of scenarios which would be provided to graduate level students as materials in a course centered around the federal income taxation of corporations. This particular problem contains 8 scenarios, scenarios 201, 203, 205, 207, 209, 211, 213, and 215. FIG. 2 is presented here primarily to illustrate the transition from problem set to data input (diagram description text file) to diagram parameters (diagram parameter text file) to actual diagrams ready for display (diagram presentation file).

FIG. 3 illustrates a diagram description text file. In the preferred embodiment, this is a text file created by the user. This file represents an intermediary step between the scenarios, as illustrated in FIG. 2, and the diagram parameter text file as would be produced in step 105. The fundamental reason for this intermediary step in the preferred embodiment is that a diagram description text file is designed to follow fairly strict protocols (note that as discussed further below, the preferred embodiment does allow for some flexibility, allowing the user to adjust input beyond what would be allowed if a completely rigid protocol were followed) so as to reduce the reliance on the natural language parsers. From this diagram description text file, the system can automatically generate the myriad of diagram parameters.

The diagram description text file preferably follows a format similar to the underlying scenarios. For example, FIG. 2 contains 8 scenarios, and the diagram description text file of FIG. 3 contains descriptions for 8 diagrams, descriptions 301, 303, 305, 307, 309, 311, 313, and 315 based on, respectively, scenarios 201, 203, 205, 207, 209, 211, 213, and 215. According to the protocol followed in the present embodiment, each diagram description (except the first) begins with a “˜” (tilde) character. Thus the system is able to determine the start of a new diagram by locating the ˜ character, and everything before that symbol is part of a prior diagram. While each diagram description is also separated by a blank line, this is not required by the protocol but is instead utilized to ease the manual reading of the document. Each diagram also begins with a Title, but the protocol does not require a title at all or that the title, if any, be inserted at the beginning of the diagram description.

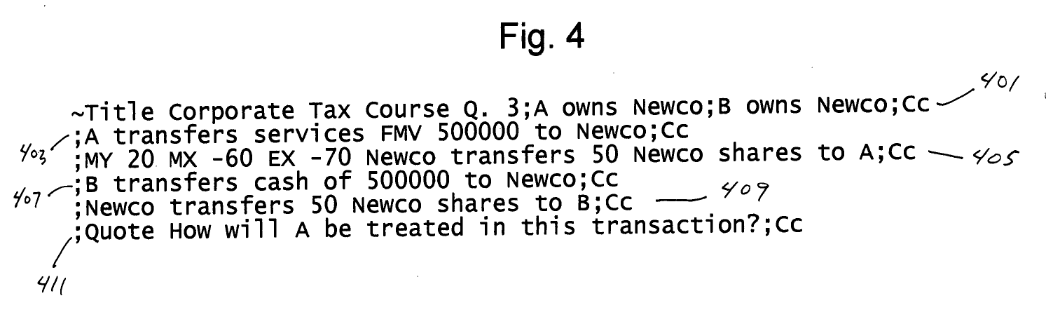

FIG. 4 represents one diagram description from FIG. 3, more particularly, description 305. This diagram description consists of 6 lines, lines 401,403,405,407,409 and 411. Line 401 consists of 3 phrases that convey meaning (i.e., 3 phrases other than comments). Each other line contains 1 phrase that conveys meaning. In the present protocol, phrases are separated by the “;” (semicolon) character. Thus, the system is able to determine the start of a new phrase (and the end of the prior phrase) by locating the; character. Line 401 ends with the characters “Cc”. In the present protocol, these symbols are intended to indicate that the phrase is for comments only and will ignored by the system. In the present example, this comment possibility is also used to skip to the next line without conveying any further meaning. Thus, each line ends with “Cc” and each following line begins with “;” as a way of providing a “carriage return” in order to make the description easier to manually read. It should be understood that the protocol does not require these carriage returns or any other comments, but that these possibilities are intended to give the user flexibility in formatting and documenting the diagram description text file. Thus, while the present example shows lines that have at most 3 phrases and generally just 1 phrase (other than comments) each line could contain as many phrases as the user's text editor would allow.

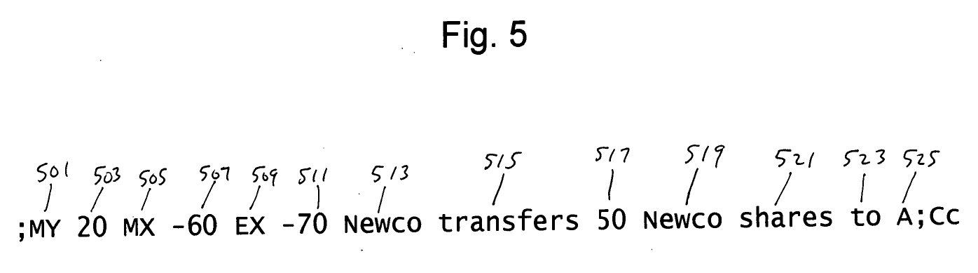

FIG. 5 represents one line from FIG. 4, more particularly, line 405. This line contains essentially one phrase (i.e., one phrase aside from the characters used to force a carriage return). This one phrase contains words 501, 503, 505, 507, 509, 511, 513, 515, 517, 519, 521, 523 and 525. These words are separated from each other by a space. The present protocol starts the first word of a phrase immediately after the semicolon (i.e., no intervening spaces or other characters). While the detailed importance of each of these words will be discussed below by reference to FIG. 6, some initial explanation would assist the reader in understanding the protocol presently employed. Words 501 through 511 serve a fundamentally different purpose than words 513 through 525. Words 513 through 525 indicate information to be displayed in the diagram. Words 501 through 511 are, in essence, signals to the system to adjust the location and format of what would otherwise be displayed. Words 501, 505 and 509 indicate which adjustment to make (three adjustments are indicated) and words 503, 507 and 511 indicate the amount for each of the three adjustments. The meaning of words 513 through 525 should be self-evident. Thus, the preferred embodiment strikes an optimal balance between the ability to express concepts in a natural fashion and an easing of the complexity of understanding (i.e., deriving useful information from) such phrases.

The process of creating the diagram parameter text file from the diagram description text file (i.e., step 105 from FIG. 1) is illustrated by reference to FIG. 6. In the preferred embodiment, the process accomplishes this step automatically (i.e., without further human input) through a personal computer utilizing Visual Basic produced by Microsoft Corporation of Redmond, Wash. Other embodiments create the diagram parameter text file through other means, such as using the C language (or some derivative of the C language) or natural language parsers.

In the first step, step 601, the system separates the diagram description text file into diagrams, phrases and words. The system accomplishes this by storing the entire diagram description text file as a string and then, through a series of substeps, separating that string into increasingly smaller components.

The first such substep is to separate the overall file (string) into individual diagrams. The system accomplishes this by locating any markers that signal the beginning of a new diagram. In the present embodiment, these markers are the tilde (˜) sign. Thus, by going through the string sequentially (character by character) from the beginning, the system creates a new substring from all such characters that follow the last tilde character (if any, since the first diagram does not require a tilde character at its beginning) up until, but not including, the next tilde character (or the string's end). The system repeats this process until the entire diagram description text file has been so analyzed, creating substrings for each such subset of characters separated by tildes, and a count kept and stored of the number of diagrams so determined. Each substring does not include the tilde character itself since that character is used solely for purposes of signaling the beginning of a new diagram and, hence, its usefulness is complete once the system has found such beginning. FIG. 3 contains 7 tilde characters, thereby signaling 7 additional beginnings of diagrams, for a total of 8 diagrams—as previously indicated, the first diagram description, description 301, does not require a tilde sign at its beginning because the system assumes that the beginning of the file is also the beginning of a diagram. It should be understood that while the explanation here refers to the initial subparts of the diagram description text file as diagrams, some of these subparts need not be diagrams as such (i.e., the system need not produce an actual diagram). For example, the user may want to insert a comment into the file where that comment is separated by tildes from other data in the file, or, if the file starts with a comment, that start may contain the comment followed by a tilde. The system would initially separate the file into substrings and later recognize that one or more such substrings do not contain data signaling the creation of an actual diagram.

The next substep involves separating each substring of a diagram into phrases. In a manner similar to the separation of diagrams, the system separates each substring containing a diagram into smaller substrings of phrases. The system accomplishes this by locating the character signaling the beginning of a new phrase. In the present embodiment, this marker is the semicolon character. Thus, by going through the substring sequentially (character by character) from the beginning, the system creates a new phrase substring from all such characters that follow the last semicolon character (if any, since the first phrase does not require a semicolon at its beginning) up until, but not including, the next semicolon character. The system repeats this process until the entire diagram substring has been so analyzed, creating substrings for each such subset of characters separated by semicolons. Each phrase substring does not include the semicolon character itself since that character is used solely for purposes of signaling the beginning of a new phrase and, hence, its usefulness is complete once the system has found such beginning. For example, FIG. 4 contains 13 semicolon characters, thereby signaling 13 additional beginnings of phrases, for a total of 14 phrases—as previously indicated, the first phrase does not require a semicolon sign at its beginning because the system assumes that the beginning of a diagram substring is also the beginning of a phrase.

The next substep involves separating each phrase substring into words. In a manner similar to the separation of diagrams and phrases, the system separates each substring containing a phrase into smaller substrings of words. The system accomplishes this by locating the character signaling the beginning of a new word. In the present embodiment, this marker is the space character. Thus, by going through the phrase substring sequentially (character by character) from the beginning, the system creates a new word substring from all such characters that follow the last space character (if any, since the first word of each phrase does not require a space at its beginning) up until, but not including, the next space character (or the end of the phrase substring). The system repeats this process until the entire phrase substring has been so analyzed, creating substrings for each such subset of characters separated by spaces. Each word substring does not include the space character itself since that character is used solely for purposes of signaling the beginning of a new word and, hence, its usefulness is complete once the system has found such beginning. For example, FIG. 5 contains 12 space characters, thereby signaling 12 additional beginnings of words, for a total of 13 words—as previously indicated, the first word does not require a space sign at its beginning because the system assumes that the beginning of a phrase substring is also the beginning of a word.

Each diagram substring, phrase substring and word substring is then saved for further processing, as described below.

While the description of the system to this point assumes that all diagrams, phrases and words will be separated before further processing, other embodiments approach this process differently. One such embodiment would separate a first diagram, separate a first phrase from that first diagram and then separate words from that first phrase. The system would then further process all those words from that first phrase (following the process described below) before separating a second phrase. Such further embodiment might sequentially separate each subsequent phrase and the words therein for further processing before separating out the second diagram and then repeat this process until all diagrams have thus been separated and processed.

The diagram description text file having been parsed into diagrams, phrases and words, the process outputs the value stored for the number of diagrams, step 602. This value is output to the diagram parameter text file, and is the first output to such file.

It should be noted that the remainder of the steps of FIG. 6 are applied to each diagram before proceeding to the next diagram. Stated differently, steps 603 through 619 are all applied first to the first diagram before any such steps are applied to a second diagram. Steps 603 through 619 are all then applied to a second diagram (if any), then to a third diagram, etc., thus looping through each diagram until all diagrams have thus been considered.

The further processing of the diagrams, phrases and words proceeds by processing as described by reference to step 603. Step 603 involves the parsing of each word for each phrase for each diagram. This preferably proceeds by processing each diagram in its entirety before proceeding to the next diagram. In the present embodiment, with the exception of the print/animate toggle, information from an earlier diagram is ignored in the processing of further diagrams. In other embodiments, additional information might be carried over from prior diagrams. This further information might include the type of display the diagrams are ultimately intended for (e.g., a PDA instead of a computer, monitor), or such other information that might be common to all diagrams produced.

The parsing of step 603 has as its ultimate objective the storage of values which can then be further processed. In the present embodiment, the parsing of step 603 occurs in 2 phases. The first phase analyzes each word of a phrase, storing values accordingly. Once the first phase has thus analyzed each word of the phrase, the second phase then derives and stores further values based on the values stored from the first phase.

In parsing each word from a phrase, it is possible for the parsing process to ignore certain words entirely—i.e., derive no meaning from those words and take no action as a result of those words being there. In the present embodiment, the only such word is “of”. In any phrase which contains the word “of” the parsing process of step 603 in essence treats that phrase as though it did not contain the word “of”. For example, the phrase “A transfers cash of 100 to Newco” would produce precisely the same result as “A transfers cash 100 to Newco”. The word “of” is used to facilitate human reading of the phrase, as well as to lessen data input errors resulting from a natural tendency to include such a word. In other embodiments other words could serve similar (or different) purposes. It should be further noted that while the present protocol ignores the word “of” by default, the present protocol allows a user to override the default. In the present protocol, this occurs through use of words indicating that an entire series of words should be stored. As further discussed below, these words include “SQ”, “Title” and “quote” and their like. For example, in the phrase, “A transfers SQ cash of 100 sq to Newco”, “cash of 100” would be stored as the value of what is being transferred from A to Newco and those words “cash of 100” would be ultimately displayed in the diagram.

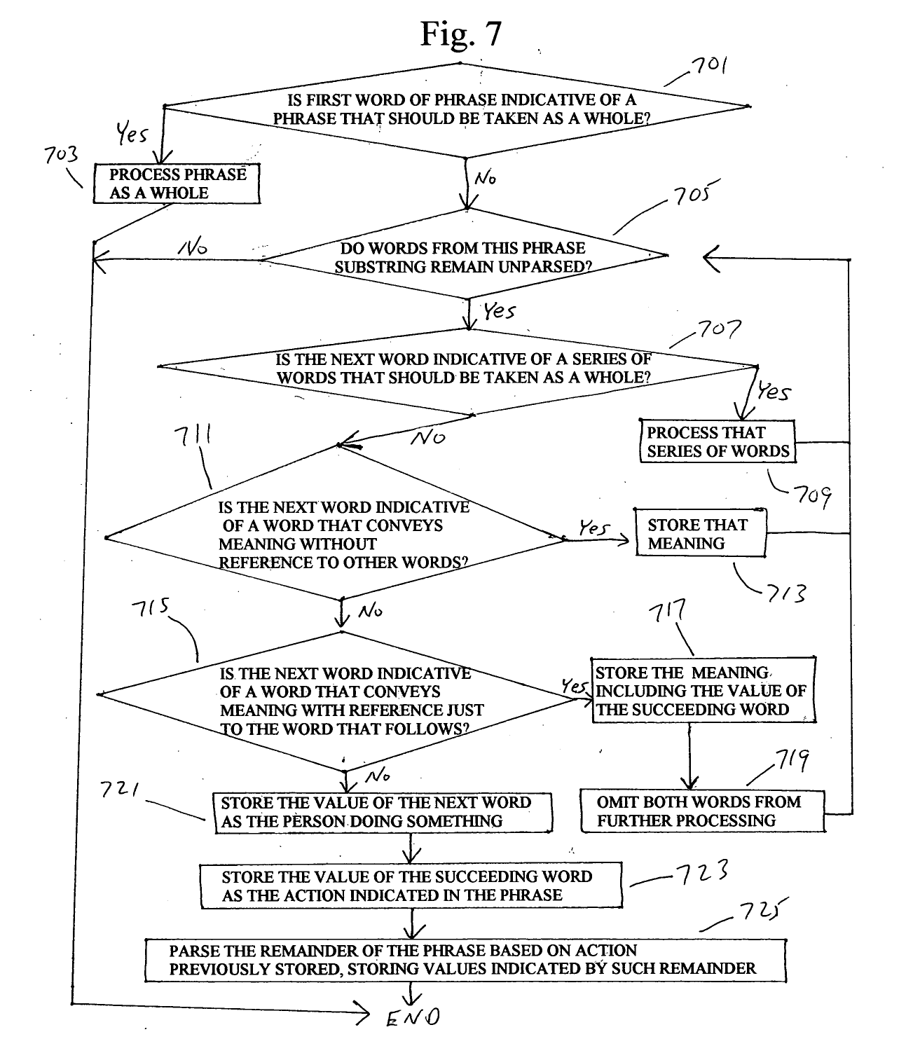

The first phase of step 603 is described by reference to FIG. 7. The first step, step 701, determines whether the first word of the phrase is a word indicative of a phrase that should be taken as a whole—i.e., no further meaning is to intended to be gleaned from the phrase. In the present embodiment, those words include “Title”, “Quote”, “quote”, “cc”, “CC”, “Cc”, “ADN”, “ARN”, “Printout” and “printout”. In these instances, the phrase should be processed as a whole storing values as indicated as follows, step 703. A phrase beginning with “Title” indicates that all words in the phrase following “Title” should be stored as the title of the diagram, to be displayed verbatim on the ultimate diagram. A phrase beginning with the word “Quote” or “quote” indicates that all words in the phrase following the first word should be stored as a quote to be displayed verbatim on the ultimate diagram. A phrase beginning with the word “CC”, “Cc” or “cc” indicates that the phrase contains nothing but a comment and should be ignored by the system—the comment is there only for the purposes of the creator of the diagram description text file. According to the present protocol, the words “ADN” or “ARN” are followed by an integer, either positive or negative. These words are used by the user to indicate an adjustment to the display of the diagram, moving the entire diagram down, in the case of “ADN” or right, in the case of “ARN”, by the number of pixels indicated by the value following “ADN” or “ARN”. Accordingly, that value is stored for later processing. A phrase beginning with the word “Printout” or “printout” indicates that all diagrams produced from the diagram description text file should be formatted for printing instead of displaying on a computer. For those phrases that are to be taken as a whole, the actions indicated above complete the processing of such phrase.

If the phrase does not start with a word indicative of a phrase to be taken as a whole, the process proceeds to step 705. This step determines whether a phrase has words yet to be parsed (i.e., subjected to this first phase of processing). If not, the first phase of step 603 is complete. Otherwise, the process determines in step 707 whether the next word is indicative of a series of words that should be taken as a whole.

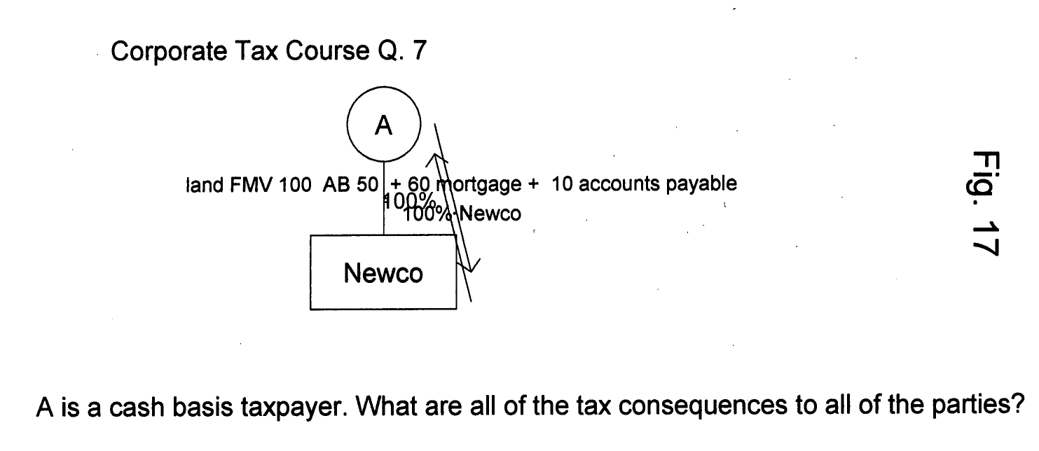

In the present embodiment, the only word indicative of a series of words that should be taken as a whole is “SQ”. This word, coupled with the word “sq” indicates that the part of the phrase in between those two words are a quote to be stored as a whole, step 709. Thus, the phrase can contain other words which will be processed as otherwise indicated, but the words between “SQ” and “sq” will be taken as a whole. This allows the user to provide a specific series of words to be displayed in a fashion otherwise indicated by the phrase. For example, the fourth line of diagram description 313 (“;A transfers SQ 10 accounts payable sq to Newco;Cc”)contains the words “SQ” and “sq”, with words in between. This system will treat “10 accounts payable” as a quote to be taken as a whole, while further processing the remainder of the phrase “A transfers . . . to Newco”. The result will be a diagram, as illustrated in FIG. 17, that displays a transfer of “10 accounts payable” from A to Newco. Upon completion of step 709, the process loops back to step 705 to determine whether additional words remain.

If in step 707 the next word is not indicative of a series of words that should be taken as a whole, then the process proceeds to step 711. Step 711 determines whether the next word is indicative of a word that conveys meaning without reference to other words—i.e., that word by itself conveys a particular meaning to be noted (and stored). If so, then step 713 would store that meaning. In the present embodiment, the words that convey meaning without reference to other words are: “Corp.”, “Inc.”, “corporation”, “Corporation” (which such words indicate that a person is a corporation); “Individual”, “individual” (which such words indicate that a person is an individual); “Partnership”, “partnership” (which such words indicate that a person is a partnership); “Trust”, and “trust” (which such words indicate that a person is a trust). Of course, other words could just as easily convey these meanings or other meanings. While these words indicate that a person is of a certain type, a question remains which person is of that type. In the present embodiment, this determination is made by reference to the location of the word in the phrase. The present embodiment adopts a protocol where the person performing an action (the “Doer”) precedes the person that is the recipient of the action (the “Doee”), i.e., the person upon whom the action is done. Thus, if the word indicating the type of person is in the beginning of the phrase, it applies to the Doer, whereas if that word is further along in the phrase, it denotes a Doee. For example, in the phrase “Corporation NewStore transfers cash of 100 to Partnership ABC”, there are two words which convey meaning without reference to other words, “Corporation” and “Partnership”. Because “Corporation” occurs at the beginning of the phrase, the present protocol will interpret that as indicating that the Doer (i.e., NewStore) is a corporation. Because “Partnership” is toward the end of the phrase, the present protocol will interpret that as indicating that the Doee (i.e., ABC) is a partnership. Of course, other embodiments could make these interpretations in other fashions. One such embodiment could associate a type to the person that follows. For example, “Corporation NewStore” could indicate that NewStore is a corporation by virtue of the fact that “NewStore” is preceded by the word “Corporation”.

Once the meaning is stored in step 713, the process loops back to step 705.

If the result of step 711 is that the next word does not indicate a word that conveys meaning by itself, the process proceeds to step 715. In step 715, the process inquires whether the next word is indicative of a word that conveys meaning when considered withjust the word that follows it. If so, the process stores the value indicated in the following such word in a location that relates to the first such word, step 717. Having stored the value in a context-sensitive location, the process then omits both words in the phrase from further processing, step 719. In the present embodiment those words triggered by step 715 are “Transaction”, “AB”, “FMV”, “to”, “MY”, “MX”, “BY”, “BX”, “EY”, and “EX”. The word “Transaction” allows the user to indicate which transaction the phrase relates to, and the word is followed by an integer corresponding to the transaction number. The word “AB” allows the user to indicate adjusted basis, a term well known to those in the tax field, and the word that follows “AB” is a number representing adjusted basis. The word “FMV” allows the user to enter fair market value, another term well known to those in the tax field, and the word that follows “FMV” is a number representing fair market value. In the present protocol, the word “to” is always followed by the name of the person upon whom an action is done (i.e., the Doee). The words “MY”, “MX”, “BY”, “BX”, “EY” and “EX” are used to adjust the placement of transactions in the diagram relative to the default produced by the process, and each such word is followed by a integer, positive or negative, indicating the number of pixels for the adjustment. Thus, while the process will automatically produce diagrams based on data provided in the diagram description text file, the user is provided the ability to fine tune the diagram automatically produced. The details of these adjustments are discussed below be reference to step 613.

If the inquiry posed by step 715 produces an answer that the next word is not indicative of a word that conveys meaning with reference to just the word that follows it, then the process continues to step 721. In the present embodiment, the first word that thus follows would be the name of a person performing an action, i.e., the Doer, and the word that follows the name of the person performing an action would be the action performed. Accordingly, the process in step 721 would store that name as the value of the Doer in the present phrase. Then, the process would store the value that follows as the Action being performed, step 723. In the present protocol, allowable Actions include: owns, owes, has, transfers, liquidates, cancels and merges. The meanings of the Actions owns, owes, transfers and cancels in the present protocol are largely equivalent to their meanings outside the field of taxation. The word “has” is used to indicate various attributes of a person. For example, A corporation could, using the “has” action, indicate it's current and/or accumulated earnings and profits, the assets it owns, or, using the SQ and sq words, any other aspect (such as net operating loss or credit carryover). The words liquidates and merges are legal terms well known to those in the field of taxation. It should be noted that the present protocol allows at most one Action per phrase and that some phrases (e.g., phrases starting with Cc, Title or Quote) contain no Action.

In step 725, the process concludes by parsing the remainder of the phrase, where that parsing varies depending on the Action previously stored in the phrase. The parsing follows a somewhat strict protocol applied for the remainder of the phrase. The present protocol allows for the following possibilities:

If the Action is “owns”, the possible alternatives for words that follow “owns” are:

1. amount, Doee, subject

2. percentage, Doee

3. Doee

4. series of words enclosed by SQ and sq, Doee

Examples of phrases containing each of the above would be, respectively,

1. A owns 100 X shares

2. Z owns 80% T

3. A owns P

4. A owns SQ 100 convertible preferred shares sq of P

Note that with regard to phrase 4, the parser would ignore the word “of”.

If the Action is “owes”, the possible alternatives for words that follow “owes” are:

1. amount

2. Doee, amount

3. Doee, series of words enclosed by SQ and sq

Examples of phrases containing each of the above would be, respectively,

1. A owes 100 to P

2. A owes P 100

3. A owes P SQ 100 subordinated debt sq

Note that with regard to phrase 1, the parser would have previously stored the values for the Doee, “P”, and removed the words “to P” (see discussion of steps 715, 717 and 719) before the processing of step 725.

If the Action is “has” the possible alternatives for words that follow “has” are:

1. subject, amount

2. subject

3. series of words enclosed by SQ and sq

Examples of phrases containing each of the above would be, respectively,

1. X has CEP of 100

2. X has equipment AB 75 FMV 200

3. X has SQ accounts receivable of 100 sq

Note that with regard to example 1, as previously indicated, the parser will ignore the word “of”. Also note that with regard to phrase 2, the parser would have previously stored the values for AB and FMV and removed the words “AB 75 FMV 200” (see discussion of steps 715, 717 and 719) before the processing of step 725.

If the Action is “transfers” the possible alternatives for words that follow “transfers” are:

1. subject, amount

2. series of words enclosed by SQ and sq

3. amount, subject 1, subject 2

4. percentage, subject

5. percentage, subject 1, subject 2

6. “assets” or “equipment” or “land”

7. “cash” or “bond” or “bonds” or “note” or “notes” or “liabilities”, amount

Note that with regard to alternatives 3 and 5, subject 1 and subject 2 essentially allow the possibility of providing 2 words to describe the subject of the action.

Examples of phrases containing each of the above would be, respectively,

1. A transfers mortgage 60 to Newco

2. A transfers SQ widget business sq to Newco

3. Newco transfers 50 Newco shares to A

4. Newco transfers 100% Newco to A

5. Newco transfers 12% Newco assets to P

6. A transfers equipment AB 45 FMV 55 to Newco

7. A transfers liabilities 300 to Newco

Note that each phrase ends with the words “to” and the name of the recipient of the transfer—the parser would have previously stored the values for such Doee, and removed the words “to” and the name of the Doee (see discussion of steps 715, 717 and 719) before the processing of step 725. Also note that with regard to phrase 6, the parser would have previously stored the values for AB and FMV and removed the words “AB 45 FMV 55” (see again the discussion of steps 715, 717 and 719) before the processing of step 725.

If the Action is “liquidates” the protocol expects no word to follow. An example of a phrase containing this Action would be, “S liquidates”.

If the Action is “cancels” the possible alternatives for words that follow “cancels” are:

1. amount, Doee, subject

2. series of words enclosed by SQ and sq, Doee

Examples of phrases containing each of the above would be, respectively,

1. P cancels 100 S debt

2. P cancels SQ 1000 subordinated debt sq of S

Note that with regard to example 2, as previously indicated, the parser will ignore the word “of”.

If the Action is “merges” there is only one type of phrase expected by the protocol:

1. “into”, Doee

An example of a phrase containing the Action “merges” would be:

1. S merges into P

It should of course be understood that while the preferred embodiment allows for the protocol as indicated above, other embodiments would allow for other protocols.

The result of applying the steps of FIG. 7 is a series of stored values derived from the data contained in the diagram description text file. The objective of this first phase is for the process to store whatever meaning can be derived from the data contained in such file. The remainder of the process achieves its purposes by reference to these values so stored.

The next function is phase 2 of step 603, which is to derive and/or store certain further information based on the values stored in the first phase. These functions in phase 2 of step 603 can be broadly categorized in one of two ways. First, certain persons that do not yet have a type assigned to them are given a default value. Second, largely because the present embodiment parses all phrases from a diagram before deriving any parameters for the diagram, the process creates arrays of the information gleaned from each phrase so that when the parameters are created, the process can derive all pertinent information gleaned from all phrases. These arrays contain such data in a form from which the diagram parameters can then be more easily derived.

As indicated by reference to steps 711 and 713, someone desiring to designate a particular type to a particular person can do so with the appropriate input into the diagram description text file. The process also provides a default type for certain persons where a type was not explicitly indicated. The process accomplishes this by reference to the name of the person. More particularly, persons with the names “A”, “B”, “C”, “D”, or “E” would by default be assumed to be individuals. Persons with then names “L”, “M”, “N”, or “O” would by default be assumed to be partnerships. Persons with the names “Newco”, “P”, “S”, “T”, “U”, “V”, “W”, “V”, “X”, “Y”, “Z”, “S1”, “S2”, “S3”, “S4”, “S5”, “S6”, “S7”, “S8” and “S9” would by default be assumed to be corporations. A person with the name “G” would by default be assumed to be a grantor trust. Persons with the names “Q” or “R” would by default be assumed to be trusts. A person that does not have a type assigned and does not have a type set by default as described above would by default be assumed to have a non-specified type. While many of these conventions for setting default types are consistent with expectations of those skilled in the tax field, such expectations are not critical in the understanding of the diagrams ultimately produced and other embodiments may therefore adopt other default type values.

In addition to assigning person types to persons, phase 2 of step 603 also stores the information gleaned from parsing each phrase so that that information can be used later in the process. In the present embodiment, the actual phrases are not stored past step 603, so the storage of these values are critical to the further processing that will create the actual parameters for the diagram displays.

In the present embodiment, for each diagram, information is stored for any Title and Quote as well as for each person, each ownership link, each transaction and each ownership attribute. For these purposes, a person is any Doer or Doee; an ownership link is a relationship between persons as indicated by a phrase where the Action is “owes” or “owns”; and a transaction is as indicated in a phrase where the Action is “transfers”, “liquidates”, “merges” or “cancels”. More particularly, for each person, the following information is stored: name, number (assigned essentially sequentially as encountered in the diagram description), and type (presently, individual, corporation, partnership, trust, non-defined, and grantor trust—these types are stored as numbers and the number associated with each type is as indicated as part of the description of step 1009). The process also assigns and stores a default column (0) and row (1) for each person, which such values are further determined by reference to step 605. For each ownership link, the following information is stored: the ownership type (equity ownership or debt ownership), the owner (or creditor), the owned (or debtor), and any label that was conveyed in the phrase. The label would include any amounts (including percentages) and subject (or subjects) indicated plus adjusted basis and/or fair market value. For each transaction, the following information is stored: transaction number assigned (if any), the Action type, the Doer and the Doee, any label that was conveyed in the phrase plus any adjustments indicated by the user in the diagram description text file (e.g., MX, MY, BX, BY, EX and EY). The label would include any amounts (including percentages), subject (or subjects) indicated plus adjusted basis and/or fair market value. For each ownership attribute, the name of the Doer (i.e., the person with the attribute) and a label would be stored. For transactions, ownership links and ownership attributes, labels can include a series of words surrounded by the words SQ and sq.

For example, from diagram description 309, the process would in step 603 store the following information:

Title: “Corporate Tax Course Q.5”,

Quote: “What are all of the tax consequences to all of the parties?”,

Persons (a total of 2): first person: name, “A”, number: 0, type: 1;
second person: name: “Newco”, number: 1, type: 2,

Ownership links (one): type: 1, owner: “A”, owned: “Newco”, label: “100%”

Transactions (a total of 2): first: number: none, Action: 1, Doer: “A”, Doee: “Newco”,

label: “land FMV 100 AB 50+40 mortgage”
second: number: none, Action: 1, Doer: “Newco”, Doee: “A”, label: “100% Newco”

Ownership attributes: none

There are several points to be noted about the preferred embodiment from the above example. First, the numbering of persons starts at 0. Second, types and actions are stored as integers instead of strings. A person type of 1 is an individual, 2 is a corporation. An ownership type of 1 is for equity ownership while a 2 (not present in the example) would be for debt. An Action with a number 1 is a transfer. Third, while diagram description indicates 3 transfers, the example above discloses only 2. In the preferred embodiment, when the same Doer transfers (or cancels) to the same Doee in unnumbered transactions, those transfers (or cancellations) are combined into one by combining the labels of the two transfers (or cancellations), hence the label “land FMV 100 AB 50+40 mortgage” for the first transaction which is a combination of two transfers.

The process takes the information stored in step 603 and then performs further functions in order to produce the parameters for the diagrams. The first such function is to determine and assign the row and column of each person indicated in the diagram, step 605. As indicated previously, each person is assigned in step 603 a default row and column. In almost every diagram, however, these defaults will be changed in step 605. The essence of step 605, more fully described below, is to determine the chains of ownership of entities and spread those chains out across the grid available for display. A very useful element of the present embodiment of the invention is that this function is performed automatically based on what is known about the persons in the diagram (i.e., based on the information stored in step 603).

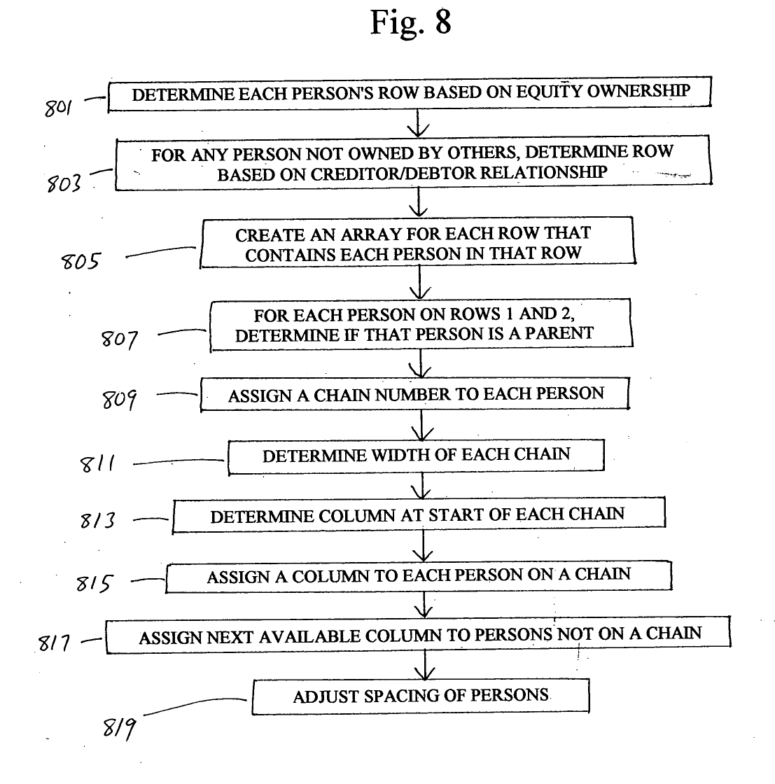

The process of determining and assigning rows and columns to persons is best understood by reference to FIG. 8. The first step, step 801, determines each person's row based on equity ownership. More particularly, step 801 relies on the information stored in step 603 as to ownership links. The process cycles through each ownership link involving equity ownership to determine if the owned person in that link has an assigned row less than or equal to the row of the owner in that link. If so, the process assigns to the owned person a row that is one greater (i.e., an integer that is greater by one) than that of the owner. The process repeats through all ownership links and then again through all ownership links a number of times equal to the number of ownership links. Thus, for example, if there are 2 ownership links, the process would make a determination once for each ownership link and then again for each ownership link (therefore a total of 4 such queries). If there were 3 ownership links, the process would make 9 such queries, etc. This iterative process is designed to ensure that the changes made on the first iteration can be used to test further links. If, for example, A owns P and P owns S, the first pass through the ownership links might place A on row 1 (where A belongs), P on row 2 (where P belongs) and S on row 3 (where S belongs), or the first pass through might put A on row 1, S on row 2 and P on row 2. In this later instance, a second pass through all ownership links would put S on row 3 where it belongs.

The process above does not fully address the row placement of persons that have cross-ownership. For example, what happens if A owns P and P owns all of S while S owns some of P? In the preferred embodiment, this situation is resolved by assigning a higher row to the company with the greatest amount of ownership (i.e., A on row 1, P on row 2 and S on row 3). More generally, the situation is resolved by reference to how underlying laws treat the cross-ownership.

The process as described above also does not address how to place persons not involved in ownership links (e.g., transfers with “third parties” that do not have an ownership or creditor/debtor relationship). In the preferred embodiment these persons retain their row assigned by default, which is row 1.

The process as described above also does not address the row of a person that does not have an equity interest in another person but does have a creditor/debtor relationship. In this instance, the process in step 803 assigns a row based on that creditor/debtor relationship. More particularly, the process places such a debtor on a row that is one greater than such a creditor. In the preferred embodiment the process would go through an iterative process comparable to that described by reference to equity ownerships described in step 801 to ensure that changes made in one pass will be reflected in links analyzed before the link with the change. It should be further noted that based on the process described by reference to steps 801 and 803, equity ownership takes precedence in determining row placement. Thus, for example, if A owns P and A owes P, A will be placed on row I and P on row 2 because the equity ownership takes precedence over the creditor/debtor relationship (which by itself would have placed P on top on A).

In step 805, the process continues by creating an array for each row so that each such array will contain a reference to each person on that row. The present embodiment allows for 5 rows (5 tiers) of persons. Accordingly, there will be 5 arrays and every person will be referenced in one and only one of those 5 arrays.

The next step, step 807, is to determine whether a person is a parent of a chain of entities. Usually, the concept of “chain” is applied to a chain of corporations, but the concept here is expanded to include partnerships. In other embodiments, the concept might also be applied to other entities such as estates and trusts. It should be further noted that in the U.S. federal income tax law, limited liability companies and limited liability partnerships have no separate tax status but are instead treated as some other type of entity, such as a partnership or corporation, or are ignored entirely—accordingly, the preferred embodiment does not have a separate type for these types of entities. Other embodiments would provide for such types of entities. In the current embodiment, a parent is a corporation or partnership that is not owned, in whole or in part, by either a corporation or partnership. Accordingly, the preferred embodiment would expect these entities to be in row 1 or row 2.

A chain of entities in the preferred embodiment consists of the parent, as described above, together with any owners of that parent (which, as described above, would not include any corporations or partnerships) together with any corporations or partnerships that the parent owns together with any corporations or partnerships that those subsidiary corporations or partnerships own, continuing down to further lower-tier ownerships. So, for example, if individual A owns stock of corporation X which has an ownership interest in partnership M which owns stock in corporation Z which owns all of corporation S, then a chain includes A, X, M, Z and S, with X as the parent because X is the top entity in the chain. In step 809, each such person in such chain is assigned the next available chain number. Accordingly, a chain number will exist for each person that is a parent, as described above, and each person on the parent's chain will have the same chain number as the parent. These chain numbers are assigned sequentially based on when the process identifies a particular parent, as described in step 807.

Ownership structures could exist where, for example, an individual owns the stock of 2 corporations where each such corporation does not have any owners that are themselves corporations or partnerships. A question then arises under the logic presented above as to which chain or chains A belongs to (i.e., which chain number is assigned to such individual). In the present embodiment, such individual would belong to the first chain that the process would include that individual in and, therefore, would not reassign that individual to the second such chain. In other embodiments, the person would be reassigned to some later chain, while in still further embodiments, reassignment would depend on further factors. In one such embodiment, reassignment would occur if the individual's ownership percentage is higher in a subsequent ownership than in an earlier ownership. In another embodiment, the user has the ability to designate, for example by placing an appropriate flag in the diagram description text file, the chain to which a person belongs thereby overriding what the process would otherwise produce.

The process would then determine the width of each chain, step 811. The process accomplishes this step by determining the width of each row on a chain and setting the width of the chain equal to the widest row on the chain. The width of a row on a chain is simply the number of persons from a particular chain on a particular row. The process makes use of data already stored (see steps 805 and 809) indicating the persons on particular rows and the chain numbers for persons. By matching up these sets of data, the process can determine the number of persons on a particular row from a particular chain.

The width of each chain is itself used to assist in the determination of the column that starts each chain, step 813. Chain 1 starts at the left of the diagram (subject to possible adjustments noted below). In the present protocol that chain occupies a number of columns equal to the width of the chain multiplied by 2. So, for example, if A owns P and A owns X and X owns T, the chain would have 1 person (A) on row 1, 2 persons (P and X) on row 2 and 1 person (S) on row 3. Accordingly, the chain would have a width of 2, equal to the widest row on that chain which is the second row. Furthermore, the chain would occupy 4 columns, the width of the chain multiplied by 2 (i.e., 2×2). The starting column of the next (second) chain would equal the starting column of the first chain (i.e., column 1) increased by the width of the first chain. Returning to the previous example, if there was a second chain, that second chain would start at the fifth column. This logic would repeat itself for subsequent chains—i.e., the starting column of any chain subsequent to the first chain equals the starting column of the prior chain increased by double the width of that prior chain.

Having determined the column to start each chain, the process then assigns a column number to each person in the chain, step 815. In the present embodiment (subject to the adjustments indicated by reference to step 819) the column assigned to a person equals 1) the starting column for the chain that person is on, 2) increased by the difference, if any, between the width of the chain and the width of this row for this chain, and 3) increased by 2 for each other person on this chain in this row for which a column has already been assigned. The first factor horizontally separates this chain from prior chains (see also the discussion above by reference to step 813). If the width of the chain on a particular row is less than the widest row on a chain, the second factor places persons on that particular row in the middle of the chain (i.e., such persons are centered). The third factor moves a person over 2 columns for each person from the chain already assigned a column—this is done simply so that one person is not on top of another. The process assigns columns in the order that persons are encountered in the diagram description text file. So, for example, if a first chain has A owning X and P, and X and P owning, respectively, S1 and S2, the chain would start at the first column, but A would be in the second column because the width of the chain is 2 (rows 2 and 3 each contain 2 persons) while the width of A's row (row 1) is 1. X and S1 would presumably be assigned column 1 (assuming that X and S1 are disclosed in the diagram description text file prior to P and S2) and P and S2 would presumably be assigned column 3. The separation of 2 columns between X and P (and between S1 and S2) allows A to be in the middle in the second column while also allowing X and P (and S1 and S2) to each occupy a width in the diagram that can exceed the width of one column. The present embodiment provides for a default width of 50 pixels for individuals, 100 pixels for corporations and 60 pixels for columns.

Step 817 assigns columns to persons not on any chain. As previously discussed, a person is on a chain if that person owns or is owned, or owes or is owed by another person. This leaves open the possibility that a first person transacts with a second person where one of the persons is not in an ownership or creditor/debtor position with any person. The present embodiment places such persons to the right of the chains that exist by assigning a column 2 higher than the highest (rightmost) column assigned to a person on a chain. Subsequent persons not on a chain are in a similar fashion assigned a column 2 removed from the last person assigned a column.

As a final step, step 819, the process adjusts the spacing otherwise determined above. If a particular diagram has only a few persons on it, the present embodiment increases a person's column by taking the column otherwise assigned, multiplying by 2 and subtracting 1. For example, if a diagram has only one chain where individuals A and B own corporation Newco, the process would initially set A's column at 1, Newco's column at 2 and B's column at 3. The process in step 819 would adjust those column assignments so as to spread them out: A still at column 1, Newco at column 3 and B at column 5. Also, if a diagram has persons occupying a large number of columns, the present embodiment reduces a corporation's width from 100 pixels to 60 pixels, which likewise has the effect of taking up less space in the diagram.

Having thus assigned rows and columns to all persons, step 605, a process described by reference to FIG. 8, the process then begins the process of more precisely determining the data to be output for a diagram and outputting that data. These outputs are to the diagram parameter text file. These outputs are based on the data already stored. The outputs are used in subsequent steps to facilitate the creation of actual diagrams.

The first such output for a diagram is the output of the counts of persons, ownership links, transactions, owner attributes and the print/animate toggle, step 607.

The next step, step 609, determines and outputs the parameters of each person involved in the diagram. The parameters output by the present embodiment for each person are the person's name, the person's type, the starting horizontal pixel location, the starting vertical pixel location, the width of the person and the height of the person. Each person's name and type are previously stored data. The starting horizontal and vertical pixel positions are based on the row and column previously assigned to that person as well as the person's type. In the preferred embodiment, pixel positions are based on slides to be prepared within Microsoft PowerPoint to be displayed on a personal computer monitor or projected through an LCD projector attached to a personal computer. In this embodiment, a person's starting horizontal pixel position is tentatively determined by subtracting one from the person's column and multiplying the result by 60. So, for example, if a person is in column 3, the tentative horizontal starting position would be 3 minus 1 multiplied by 60 (i.e., (3−1)×60) which is 120. This starting horizontal pixel position means that the person will occupy a space with a leftmost point that is 120 pixels from the left edge of the display. In this embodiment, a person's starting vertical pixel position is tentatively determined by subtracting one from the person's row and multiplying the difference by 100. So, for example, if a person is on row 2, the person's tentative vertical starting position would be 2 minus 1 multiplied by 100 (i.e., (2−1)×100) which is 100. The present embodiment provides for adjustments to these tentative starting positions. One set of adjustments is applied to reflect the varying sizes of spaces occupied by different types of persons. For example, while corporations generally occupy a rectangular space of 100 pixels wide by 50 pixels high, individuals occupy a circular space with a diameter of 50. What is meant by a person occupying a certain space is that a shape is displayed in that diagram occupying that space with the person's name inside that shape. The present protocol provides that the rectangular space of the corporation begin (subject to any further adjustment—see below) at the tentative starting points while the circular space of an individual generally starts 25 pixels to the right of the tentative starting points. Accordingly, the starting pixel positions for individuals will generally be increased by 25 in the horizontal direction, 0 in the vertical direction. These adjustments result in all persons in the same column being centered relative to each other. Another adjustment might be made to reflect user preferences. In the previous discussion by reference to steps 701 and 703 of FIG. 7, mention was made of the possibility that a user could use the words “ADN” and “ARN” in the diagram description text file for the purpose of adjusting the diagram, respectively, down and/or to the right. If either or both of these options are used, the tentative starting positions of each person will be increased by the number of pixels so indicated by the user. For example, if a user included a phrase “ADN 75;” in the description of a particular diagram in the diagram description text file then the starting vertical pixel position for each person in that diagram would be increased by 75 from the tentative amount. Thus a person on the second row would have a starting vertical pixel position of 175 (i.e., ((2−1)×100)+75), ignoring any adjustment for the type of person, discussed previously. The final components of the output for each person in step 609 are the person's width and height. These dimensions are expressed in pixels of the ultimate display intended. In the present embodiment, each person has a width of 50 pixels and a height of 50 pixels except for corporations that generally have a width of 100 and a height of 50. In other embodiments, the width and height are not output to a diagram parameter text file, those dimensions are determined in a later process by reference to the type of the person which is output.

In step 611, the process determines and outputs the parameters for each ownership link. In the present embodiment, an ownership link is displayed on the ultimate diagram as a line—a solid line to represent ownership and a dashed line to represent debt—with the further possibility of displaying text (i.e., a label) to accompany that line. Accordingly the data that is output for each ownership link is a label (if any), type (equity or debt), starting horizontal pixel position, ending horizontal pixel position, starting vertical pixel position and ending vertical pixel position. The pixel positions indicate the starting and ending points of the line representing the ownership link. The label and type values output are those previously stored as discussed by reference to step 603 and FIG. 7. The pixel positions are derived based on information previously stored (also as discussed by reference to step 603 and FIG. 7) about the two persons involved in this link—i.e., the owner (or creditor) and the owned (or debtor). The starting horizontal and vertical pixel positions of each person (as adjusted) were derived in step 609. Step 611 derives the pixel positions of the ownership links from the pixel positions of the persons involved. More particularly the line of ownership (and therefore the pixel positions) is tentatively set to connect the closest sides of the spaces of the two persons in the middle of such side of each such person. For example, if in a first chain, individual A owns corporation P and P owns corporation S, and if there are no adjustments to the tentative pixel positions, the starting horizontal pixel positions, starting vertical pixel positions, width and height of the persons involved would be, respectively: A: 25, 0, 50 and 50; P: 0, 100, 100 and 50; S: 0, 200, 100 and 50. There would be 2 lines indicating ownership, between A and P, and between P and S. As indicated above, in each instance these lines connect the persons in the middle of the sides of each person closest to the other person. Because A is above P, the line would be from the bottom middle of A to the top middle of P. More particularly, the line would have starting horizontal, starting vertical, ending horizontal and ending vertical coordinates of, respectively, 50, 50, 50 and 100. Likewise, because P is above S, that line would be from the middle bottom of P to the middle top of S. More particularly, the line would have starting horizontal, starting vertical, ending horizontal and ending vertical coordinates of, respectively, 50, 150, 50 and 200.

In the case of a link indicating debt, the preferred embodiment makes an adjustment to the coordinates produced above. More particularly, the starting and ending horizontal pixel positions are decreased by 12, thereby shifting such line 12 pixels to the left. This adjustment is made to further distinguish from lines of equity ownership and to ensure that an equity line of ownership does not overlap a debt line.

In step 613, the process determines and outputs the parameters for each transaction. With several modifications, a transaction is essentially displayed along a line from the Doer to the Doee. As discussed more fully below, this line may be an actual line to be displayed or a theoretical line along which something else is displayed. These lines are determined based on values (as adjusted) previously stored for the spaces these persons occupy. The values output for each transaction are the transaction number (if no number is assigned to a transaction by the creator of the diagram description text file then the present embodiment assigns a number of 0 to each such transaction not assigned a number by such creator), type, label (if any), starting horizontal pixel position, ending horizontal pixel position, starting vertical pixel position, and ending vertical pixel position. The values for transaction number (if any), type and label (if any) are those previously stored as discussed by reference to step 603 and FIG. 7.

The line along which a transfer or cancellation transaction is displayed is tentatively set to begin vertically in the middle and horizontally slightly (10 pixels) to the right of the space occupied by the Doer. Likewise, the line ends vertically in the middle and horizontally slightly (again 10 pixels) to the right of the space occupied by the Doee. For example, if in a first chain individual A owns corporation P and P makes a transfer to A (and where the starting horizontal pixel positions, starting vertical pixel positions, width and height of the persons involved would be, respectively: A: 25, 0, 50 and 50; P: 0, 100, 100 and 50), the line along which that transfer is displayed has starting horizontal pixel position, ending horizontal pixel position, starting vertical pixel position, and ending vertical pixel position of, respectively, 110, 85, 125 and 25. These tentative beginning and ending points are then adjusted to reflect prior transfers or cancellations output for this Doee, thus avoiding an overlap. More particularly, the present embodiment decreases the ending vertical position (i.e., moves up) for each additional transfer or cancellation by 25 pixels.

The line along which a liquidation or merger transaction is displayed is tentatively set to approximately the middle of the sides of the Doer and Doee nearest to each other. In the present embodiment, the approximation is not exact in that the beginning and ending points are adjusted 5 pixels away from the middle of the space occupied by the Doer and Doee, although in other embodiments, such adjustments are not applied. In the present embodiment, for example, if a first chain has individual A owning corporation P and corporation P owning corporation S, and if S liquidates into P (and where the starting horizontal pixel positions, starting vertical pixel positions, width and height of the persons involved would be, respectively: A: 25, 0, 50 and 50; P: 0, 100, 100 and 50; S: 0, 200, 100 and 50), that liquidation would be displayed along a (theoretical) line that has starting horizontal pixel position, ending horizontal pixel position, starting vertical pixel position, and ending vertical pixel position of, respectively, 55, 55, 200 and 150.

The step of outputting parameters for transactions then varies depending on whether the creator of the diagram description text file added a phrase “printout;” at some point in that file, thus designating that the displays to be generated by the process are intended for printing (i.e., setting the print/animate toggle to print, which in the present embodiment is represented by the integer 1) as opposed to display from a computer monitor or other display connected to a personal computer (i.e., by default—nothing is indicated—the print/animate toggle is set to animate, which in the present embodiment is represented by the integer 2). If this print/animate toggle is set to animate the values to be output (transaction number (if any), type, label (if any), starting horizontal pixel position, ending horizontal pixel position, starting vertical pixel position, and ending vertical pixel position) have thus been determined and are therefore output to the diagram parameter text file.

If the print/animate toggle has been set to print, further adjustments are made prior to output. The primary essence of these adjustments is to ensure that the lines along which the transactions are displayed do not overlap with other information presented in the diagram, such as other transactions, spaces occupied by persons and owner attributes. While these issues also theoretically exist where the display animates the transactions, the animation of the transactions in the current embodiment occupies less space (the lines in the printed version contain actual printed matter while the lines in the animated version are theoretical lines along which the animation moves) and, because the transactions are presented in motion, any crossover is more likely to be transitory and therefore less distracting.

As previously indicated, in the animated version, the necessary data is output all at once (i.e, in one command). This data consists of the pixel positions of the line for the transaction, any label (there need not be one), any transaction number (there need not be one), and the transaction type.

In the printing mode (i.e., the print/animate toggle has been set to print) of the present embodiment, the output of transactions is not accomplished all at once. Instead, each transaction is separated into a series of components. There will be one component for each line that will be printed, and another component for any label. Each one of these components requires the output of a separate line of data, where that line of data consists of a transaction number, type, label, starting and ending horizontal and starting and ending vertical pixel positions. In addition, a separate line of data is output to signal the end of the components for all transactions. As more fully described later, many of the data items output are ignored—they are nonetheless output to ensure uniform input later in the process. If a command is executed to output data which contains the coordinates of a line but no label, then the result from further steps in the process will be to produce a line in the display with no label. Also, if a command is executed to output data which contains a label and the coordinates of a line where 2 of those coordinates indicate the point of placement of the label in the display, then the result from further steps in the process will be to print the label at the coordinates so provided and to not print a line. These facts are used by the process to produce the many lines as well as any label that might be called for in the diagram for a particular transaction. In essence, every time that the process requires some aspect of a transaction to be printed, the command to output the previously mentioned data (number, type, label and four coordinates) is executed. Some of the data output in each such case may be ignored by further aspects of the process.

With this background in mind, the process proceeds to make adjustments to the line of each transaction previously determined. One set of adjustments is designed to prevent lines from crossing over the spaces of the persons involved in the transaction. If one such person is to the right of the other such person, the coordinates for the line of the transaction are adjusted such that the line extends from the right of the person on the left to the left of the person on the right. Another adjustment is made to move down (i.e., increase the starting and ending vertical coordinates) a line of a transaction if the process has already output a line of a transaction between these two persons where the transaction goes the other direction, thus preventing displaying one transaction on top of another. A further adjustment places labels for cancellations slightly to the right of the position otherwise produced.

The determinations of the tentative lines of a transaction and the adjustments provided for above are designed to automatically produce a clearly understandable printed diagram. The user may nonetheless believe that fine-tuning the placement of aspects of the transactions would be useful. The process therefore allows for the entry of data into the diagram description text file that will be interpreted by the process as a flag to adjust the lines of a transaction that would otherwise be produced. Realistically, these flags would be ideally implemented by having the process first produce diagrams without these flags, the user visually inspecting the resulting diagrams, then the user entering the appropriate flags into the diagram description text file (modifying that file by including the appropriate words and their values). Once the words and values for these adjustment flags are entered into the diagram description text file, the process will automatically produce the diagrams where these diagrams will be so adjusted. In the present embodiment, there are 6 different fine tuning adjustments that can be so indicated in the diagram description text file. These adjustments, together with the appropriate word to invoke the adjustment, are as follows: BX, BY, EX, EY, MX and MY. These words are placed into a phrase that otherwise contains a transaction (thereby associating such adjustments with such transaction) where each such word is immediately followed by a number (negative or positive), such number indicating the number of pixels of such adjustment. Line 405 of FIG. 4 illustrates a phrase that contains some (i.e., MY, MX and EX) of such adjustments.

The words BX, BY, EX and EY are used to adjust the starting and/or ending points of the line that would otherwise be produced. More particularly, the process will increase (or decrease if a negative value) the starting horizontal pixel position, starting vertical pixel position, ending horizontal pixel position and ending vertical pixel position by the values entered for BX, BY, EX and EY, respectively. For example, in a phrase “EX −70 Newco transfers 50 Newco shares to A”, the process would determine the coordinates of the line for the transaction as though the words “EX −70” were not present and then the ending horizontal pixel coordinate so derived would be deceased by 70 (leaving all other coordinate values unchanged). The result in the diagram would be a line the end of which is shifted horizontally to the left.

The user may believe that the fine tuning possible by shifting a line still does not produce optimal clarity. Further adjustments are possible through the use of the MX and MY flags. These flags have the effect of producing 2 lines to display a transaction in place of one. The first such replacement line has the starting horizontal and vertical coordinates of the original one line. The second such replacement line has the ending horizontal and vertical coordinates of the original one line. The first such replacement line ends at the same point that the second such replacement line begins—i.e., the two such replacement lines are connected to each other and hence share one set of coordinates. That one set of coordinates representing the point at which the two lines connect is tentatively set at the midpoint of the one original line. The MX and MY flags can then alter that point of connection and, as a result, produce what is in essence an angled line. MX and MY indicate the number of pixels by which to adjust, respectively, the horizontal and vertical coordinates of the midpoint (i.e., the point of connection). For example, if a transaction line would otherwise extend from coordinates 50, 100 to 350, 100, the midpoint would normally be 200, 100. If a MX value of 50 and a MY value of −60 were used, the process would produce two lines:

1. 50, 100 to 250, 40

2. 250, 40 to 350, 100.

The process further allows for the use of a combination of the BX, BY, EX, EY, MX and MY flags. The preferred embodiment adjusts for the BX, BY, EX and EY flags prior to the MX and MY flags. For example, if the process would otherwise produce a transaction line extending from coordinates 50, 100, to 420, 100, and if the user entered the flags MX 50, MY −60, EX −70, the process would first tentatively set the coordinates of one line as 50, 100 to 420, 100 then apply the EX adjustment to produce one line with coordinates 50, 100, to 350, 100, and then apply the MX and MY adjustments by determining an initial midpoint of 200, 100, adjusting that midpoint based on the MX and MY values such that the midpoint coordinates would be 250, 40 and the two lines produced would have the following coordinates:

1. 50, 100 to 250, 40

2. 250, 40 to 350, 100.

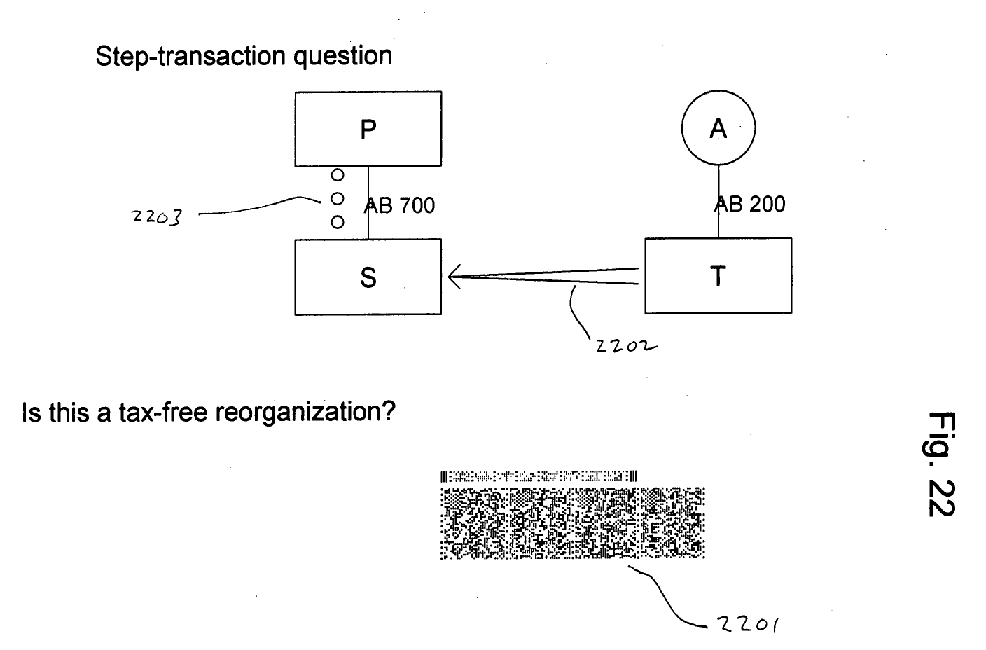

The adjustments having been made, the process may need to derive further data before it outputs the data relating to the parameters for transactions. For merger transactions, the preferred embodiment displays the printed transaction as an arrow that consists of two lines of the transaction where those two lines meet at a point where an arrow head is formed. Both of the two lines of the merger transaction end at the same point that the process above (with adjustments) determines to be the end of the line of the transaction. The two lines of the merger transaction begin at approximately the same point that the process above (with adjustments) determines to be the beginning of the line of the transaction. These beginnings are only approximate though—the process determines the normal beginning and then offsets that beginning by a few pixels in opposite directions so that two lines can be formed. FIG. 22, discussed infra, illustrates an example of a printed merger transaction. For mergers and transfers, the process determines the lines that make up the arrow head of the main line of the transaction. The end point of each arrow line are also the end point of the main line of the transaction—therefore the 3 lines (main and 2 arrow head lines) share the same ending coordinates. The process determines the different beginning coordinates for the 2 lines of the arrow head.

The necessary data for the transaction parameters having been determined, the process then outputs the data. As previously noted, the process executes a different command for each line determined by the process. In the case of a transfer, for example, that might be 4 outputs—1 main line, 2 arrow head lines and 1 for the label. A merger would also call for 4 outputs—2 main lines and 2 arrow head lines, the present embodiment does not allow for a label to be attached to a merger. Other embodiments would allow for a label to be attached to a merger.

In step 615, the process outputs any Quote and Title that was parsed from data entered by the user into the diagram description text file. The values for the labels of the Quote (if any), and Title (if any) are those previously stored as discussed by reference to step 603 and FIG. 7. In the present embodiment, the Title is assumed to be no more than one line long as displayed while a Quote could occupy approximately 11 lines of the display. The only data output for the Title is the label (i.e., the actual title as indicated by the user). For the Quote, the preferred embodiment outputs both a label and its starting vertical position. The starting vertical position is set at one row below the deepest row occupied by a person in the diagram, as previously determined. For example, if a diagram has A owning P (and no other persons), A is on row 1, P is on row 2, the quote would begin on row 3. Where, as in the preferred embodiment, each row occupies 100 pixels vertically (and assuming no other adjustments), the diagram would have A starting at vertical position 0, P at vertical pixel position 100 and the quote at vertical pixel position 200.

The description as presented to this juncture raises an issue of where the Title, if any, would be placed in the display so as to not interfere with other items being displayed. It should be further noted as pertains to this issue that the data output for a Title by the preferred embodiment to the diagram parameter text file is only the label—i.e., the actual Title to be displayed—and not any position coordinates. One possible resolution to this issue is to place the Title at the very bottom of the display. Another resolution is to place the Title at the next available spot available at the bottom—this spot would not necessarily be the very bottom of the display, but would be below everything else being displayed. In the preferred embodiment, the Title is displayed at the very top of the display. This requires that everything else to be displayed be moved down (i.e., vertical pixel position increased). The manner in which the preferred embodiment accomplishes this is described more fully by reference to step 107.

The next step in the process of creating the diagram parameter text file, step 617, is the determination and output of any owner attributes. Those attributes include the label (text) and the horizontal and vertical pixel position at which to place the label. The label is the value previously stored as discussed by reference to step 603 and FIG. 7. The horizontal and vertical pixel position is determined by reference to the starting horizontal and vertical pixel position as well as the height and width of the owner of the attribute, all as determined (with adjustments) as indicated previously (also as discussed by reference to step 603 and FIG. 7). More particularly, the preferred embodiment places (starts) such attributes underneath (i.e., vertical pixel position equal to the owner's starting vertical pixel position plus the person's height) and slightly to the right of the horizontal middle of the owner (i.e., horizontal pixel position equal to the owner's starting horizontal pixel position increased by 50% of the owner's width further increased by 5 pixels). The preferred embodiment allows for the display of multiple owner attributes. This creates an inherent issue where, unresolved, a plurality of owner attributes would be displayed on top of each other. The preferred embodiment solves this problem by placing each subsequent attribute for a particular owner 16 pixels down (i.e., vertical pixel position is increased by 16) from the prior attribute whose pixel position was determined.

In step 619, the process determines whether there are more diagrams to be parsed in the diagram description text file. The process preferably makes this determination by reference to the count of the number of diagrams as output in step 602. If there are further diagrams to parse, the process loops back to step 603. If the answer to the query of step 619 is that there are no more diagrams to parse then the process of determining and outputting the diagram parameter text file is completed and that file can therefore be closed. The file is stored and the contents of the file are made available for further processing toward the creation of the displays.

An example of the total contents of a diagram parameter text file is provided in FIG. 9. This file would be produced by reference to description 307 of FIG. 3—i.e., the process would produce this diagram parameter text file if description 307 was the only diagram described in the diagram description text file. Note that if the diagram description text file had description 307 as its only contents then such file would not contain the phrase “printout” and, hence, the print/animate toggle would by default be set to animate. Also note that while the diagram parameter text file would not contain the labels of what is being output (e.g., Person Count) these labels are presented in FIG. 9 in brackets to facilitate understanding. The actual output should therefore be understood as not including the information in brackets. It should be further understood that while in the actual file, the output occurs sequentially without spaces or carriage returns, the information in FIG. 9 contains spaces and carriage returns, again to facilitate understanding.

While the preferred embodiment has been described such that all diagrams are printed or all diagrams are animated, other embodiments handle this issue differently. One such embodiment allows the user to separately flag (e.g., by placing the flag, “printout” or “Printout” in the diagram description text file) each diagram. Another embodiment would produce for the same scenario an animated diagram followed by a “printed” diagram. This embodiment could be useful for at least two reasons. When displaying a scenario, the animated diagram conveys information about the sequence of events and allows the user to absorb each step in the sequence before proceeding to the next step. Then, when all steps are complete, the “printed” version could be displayed, which would simultaneously display all of the transactions in the scenario. This second display could be left on the screen in order to reinforce the details of the scenario. The printed version could also be useful for actually printing the diagram.

Having produced the diagram parameter text file, the process then creates a diagram presentation file containing the diagrams to be displayed, step 107. The preferred embodiment creates a Microsoft PowerPoint file containing a slide for each diagram. This embodiment creates these files by applying macros written in Visual Basic. These macros access the data from a diagram parameter text file and create the items displayed on a slide based on that data. In other embodiments, the diagram presentation file is not a PowerPoint file. In some such embodiments, the diagram presentation file consists of a series of images created by software written to create images from the data contained in the diagram parameter text file. In some embodiments, the process of determining the data for parameters consistent with the process previously described is followed by a process for creating images to be displayed. Stated differently, while the preferred embodiment has one program for creating the diagram parameter text file and another for creating the diagram presentation file, other embodiments perform both functions as part of one program. In some embodiments, the images created are not still images but are instead animated images. While the preferred embodiment utilizes the functionality built into PowerPoint for creating images, including where indicated, animated images, from data, other embodiments include programs written to accomplish this functionality. In some embodiments, only one diagram is produced from the data contained in the diagram parameter text file, preferably due to the fact that diagram parameter text file contains parameters for just one diagram.

The process of the preferred embodiment for accomplishing step 107 is described by reference to FIG. 10. Step 107, as more fully described by reference to FIG. 10, has as its primary function the accessing of data from the diagram parameter text file and then placing display items based on that data so accessed. This placement largely entails determining the location of each display item based on the data accessed from the diagram parameter text file. But, as fully described below, these locations may be adjusted down or to the right primarily for reasons of, respectively, making room for a Title and aesthetics.

The description of the preferred embodiment to this point leaves open the issue of where to place the Title, if any, of a particular display. The preferred embodiment resolves this issue by having the process in step 107 move each item in the display, for those diagrams with Titles, down by a uniform number of pixels (i.e., increase the vertical pixel position) so that the top space represented by such number of pixels would be available only for the Title. The present embodiment allows 50 pixels for the Title, thus moving all other items down by 50 pixels. Other embodiments would resolve the issue by other means. In one such embodiment, the issue is resolved by adding a set number of pixels to each item in the display before the pixel positions are output to the diagram parameter text file.

In a similar vein to the issue of moving the display down in order to make room for the Title, the preferred embodiment also allows the creator of a slide or series of slides to adjust all items displayed some number of pixels to the right. The preferred embodiment as described to this juncture sets parameters such that items are displayed beginning at the left edge of the display. While such an approach ensures maximum space to display items, such space is not needed in simple displays, and a more visually pleasing display would result from moving everything in the display to the right. The creator of the slide or slides could move all items in a slide using the “ARN” parameter, discussed by reference to steps 701 and 703. This technique would apply to all of only one slide. One embodiment allows for the possibility of moving all items of all slides to the right of default. This is preferably accomplished by adjusting all items in a display to the right (i.e., adding a set number of pixels, e.g., 200, to the horizontal pixel position). One such embodiment accomplishes this adjustment by having the process in step 107 move each item in the display. Other embodiments would resolve the issue by other means. In one such embodiment, the issue is resolved by adding a set number of pixels to each item in the display before the pixel positions are output to the diagram parameter text file.

The first step in creating the diagram presentation file from the data contained in the diagram parameter text file is to access from the diagram parameter text file the count of the number of diagrams, step 1001.

Step 1003 begins a loop for processing each diagram. Step 1003 starts this process by determining whether there are more diagrams to process. This loop is performed for each of the diagrams indicated by the count of diagrams derived in step 1001. If the answer to step 1003 is that there are no further diagrams to create, then the process described in FIG. 10 is complete, having produced a diagram presentation file.

If the answer to step 1003 is that there are more diagrams to produce then the process applies a series of steps, steps 1005 through 1037, for each diagram to produce the diagram.

In step 1005, the process accesses from the diagram parameter text file the counts of the persons, ownership links, transactions, and owner attributes and the print/animate toggle for the next diagram. It should be noted that, consistent with a prior description, once the preferred embodiment sets the print/animate toggle to print for any diagram, that toggle is set to print for all diagrams. This consistent value is stored for each diagram and, in step 1005, accessed for each diagram. In other embodiments, the toggle could vary between diagrams and the process in step 1005 would access those varying toggle values for each diagram. In still further embodiments, the process could produce both animated and printed diagrams for the same scenario, either for flagged descriptions or all descriptions.

The process then starts a loop for each person indicated by the count of persons accessed in step 1005. This loop consists of 2 steps, steps 1007 and 1009. In step 1007, for the next person, the process accesses the name, type, starting horizontal and vertical pixel positions, width and height. The process accesses this data from the diagram parameter text file.

In step 1009, the process places the person in the diagram. The process does this by using the data accessed in step 1007. In the preferred embodiment, utilizing a Visual Basic macro in Microsoft PowerPoint, the process executes a command where that command takes as input a shape, starting horizontal pixel position, starting vertical pixel position, width and height and, if any, text, and creates as part of a slide a shape of the type, height and width so indicated, at the starting pixel positions so indicated, and within that shape the text for the name accessed in step 1007. The pixel positions are those accessed from the diagram parameter text file in step 1007, as adjusted down and to the right in the preferred embodiment by the same number of pixels that all display items are adjusted—in the current embodiment 50 pixels down and 200 pixels to the right—as more fully discussed at the beginning of the discussion of FIG. 10. The process determines the shape based on the type of person, with the types and shapes of the present embodiment as follows:

| Type | TypeNumber | Shape |
|---|---|---|
| Individual | 1 | Circle |
| Corporation | 2 | Rectangle |
| Partnership | 3 | Triangle |
| Trust | 4 | Pentagon |
| Non-defined | 5 | Doughnut |

An example of the command employed where the person is an individual is:

With CurrDoc.Shapes.AddShape(msoShapeOval, phoriz, pvert,
pwidth, pheight).TextFrame
.TextRange.Text = pName
.MarginBottom = 10
.MarginLeft = 10
.MarginRight = 10
.MarginTop = 10
End With

The following should be noted with regard to the example command above. First, CurrDoc is the name of the current slide being processed—i.e., the current diagram. Second, phoriz, pvert, pwidth, and pheight are, respectively, the starting horizontal pixel position, starting vertical pixel position, width and height. Third, the process would have stored in the diagram parameter text file the height and width as equal numbers so as to produce an oval that is a circle. Fourth, pName is the text stored in the diagram parameter text file as the name of the person. Fifth, the margins are set so as to produce a shape with the name centered in such shape.

As previously indicated, the process in steps 1007 and 1009 is repeated for each person in the diagram, as indicated by the count of persons.

The process performs similar functions for ownership links in steps 1011 and 1013. These two steps are performed for each ownership link indicated by the count of ownership links as accessed in step 1005. In step 1011, the process accesses for the next ownership link, the label, type, starting and ending horizontal pixel positions and the starting and ending vertical pixel positions.

In step 1013, the process places the ownership link in the diagram. The process does this by using the data accessed in step 1011. In the preferred embodiment, again utilizing a Visual Basic macro in Microsoft PowerPoint, the process executes two commands. The first command takes as input a starting horizontal pixel position, starting vertical pixel position, ending horizontal pixel position and ending vertical pixel position. The first command creates a line from the beginning pixel position indicated by the starting horizontal and vertical pixel positions to the ending pixel position indicated by the ending horizontal and vertical pixel positions. These pixel positions are those accessed from the diagram parameter text file in step 1011, as adjusted down and to the right in the preferred embodiment by the same number of pixels that all display items are adjusted—in the current embodiment 50 pixels down and 200 pixels to the right—as more fully discussed at the beginning of the discussion of FIG. 10. If the type of ownership, again as indicated from the data accessed in step 1011, is equity (type=1), the process creates a solid line. If the type of ownership is debt (type=2), the process creates a dashed line. The second command creates a label that is displayed at a point that is approximately the midpoint of the ownership link. This label contains any text accessed in step 1011. The present embodiment creates this label in the display by also creating a shape and then associating the text with this further shape. The present embodiment creates a circle that is intentionally made very small (3 pixels in diameter) so as to not obstruct other items displayed or otherwise distract from the other items displayed. In other embodiments, the text is placed in the display without also placing a shape of any size.

An example of the 2 commands used to create a display of an ownership link (in this instance, equity) is as follows:

With CurrDoc.Shapes.AddLine(Ohorizb, Overtb, Ohorize, Overte).Line
.DashStyle = msoLineSolid
.ForeColor.RGB = (50, 0, 250)
End With
With CurrDoc.Shapes.AddShape(msoShapeOval,
((Ohorizb + Ohorize) / 2) ((Overtb + Overte)/2),_{— 3, 3).TextFrame}
.TextRange.Text = Olbael
.MarginBottom = 10
.MarginLeft = 50
.MarginRight = 10
.MarginTop = 10
.TextRange.Font.Color..RGB = RGB(50, 0, 250)
.TextRange.Font,Size = 15
End With

The following should be noted about the prior 2 commands. First, CurrDoc is the name of the current slide being processed—i.e., the current diagram. Second, Ohorizb, Overtb, Ohorize, and Ohorize are, respectively, the starting horizontal pixel position, starting vertical pixel position, ending horizontal pixel position and ending vertical pixel position. Third, the process displays equity ownership as a solid line, debt ownership as a dashed line. Fourth, Olabel is the text stored in the diagram parameter text file as the label associated with this ownership interest (e.g., “50%” in the instance where a person owns 50% of the stock). Fifth, the ForeColor, Font.Color and Font.Size commands are used to add different colors and/or fonts so as to further distinguish from other items displayed. Sixth, the margins used were determined after some experimentation to produce an optimal display.

The next series of steps, steps 1015 through 1025, involve the accessing and placing of display items related to transactions. This function is the most complicated, taking more steps, because the process provides more options than for the other display items. In particular, this function might result in either a static display or an animated display, depending on the print/animate toggle accessed in step 1005. The process has one set of steps for printing, another for animation.

The first step in this process of displaying transactions, step 1015, is to determine whether the print/animate toggle is set to animate (i.e., a value of 2). If the answer to the query of step 1015 is that the toggle is set to animate, the process continues on to step 1017. If the answer to the query of step 1015 is that the toggle is set to print, the process continues to step 1021. In either instance—i.e., regardless of whether the process continues next to step 1017 or 1021—the process ultimately continues to step 1027 after the intervening steps indicated below.

Where the print/animate toggle indicates animation, the process proceeds to steps 1017 and 1019, and applies each of those steps for each transaction. In step 1017 the process accesses for each transaction the transaction number, type, and label as well as the starting horizontal and vertical pixel positions and ending horizontal and vertical pixel positions.

In step 1019, the process places the transaction in the display. This step involves first selecting a shape and shape size depending on the type of transaction. In the present embodiment the shapes are as follows:

| Type of | | | | |
|---|---|---|---|---|
| Transaction | Type Number | Shape | Width | Height |
| transfer | 1 | star | 6 pixels | 6 pixels |
| liquidation | 2 | wave | 25 pixels | 8 pixels |
| merger | 3 | arrow | 20 pixels | 20 pixels |
| cancellation | 4 | a “no symbol” | 20 pixels | 20 pixels |

While these shapes and sizes were selected after experimentation to determine aesthetically suitable choices, other embodiments might use other shapes and/or sizes to good effect. Step 1019 further entails associating any transaction label with the shape so determined. Finally, step 1019 includes a command that will move the selected shape and associated text along a path where the beginning of the path is determined by the starting horizontal and vertical pixel positions accessed in step 1017 and the end of the path is likewise determined by the ending horizontal and vertical pixel positions accessed in step 1017.

An example of Visual Basic commands utilized to place a transfer (type 1) is as follows:

```
Set TransShape1= ActivePresentation.Slides(sl).
Shapes.AddShape(Type:msoShape5pointStar, _{—}
  Left:=thorizb, Top:=tvertb, Width:=6, Height:=6)
Set effCustom1 =ActivePresentation.
Slides(sl).TimeLine.MainSequence.AddEffect(Shape:=TransShape1,
_{—}
  effectID:=msoAnimEffectCustom)
Set animBehavior1 = effCustom1.Behaviors.Add(msoAnimTypeMotion)
With TransShape1.TextFrame
.TextRange.Text = tlabel
.MarginBottom = 50
.MarginLeft = 70
.MarginRight = 10
.MarginTop = 75
End With
With effCustom1.Timing
.Duration = 3
.TriggerDelayTime = 0
.RenewAtEnd = msoFalse
End With
With animBehavior1.MotionEffect
.FromX = 0
.ToX = ((thorize − thorizb) / 723)
.FromY = 0
.ToY = ((toverte − tvertb) / 541)
End With
```

The following should be noted with regard to the example commands above. First, thorizb, thorize, tvertb, and tverte are, respectively, the starting horizontal pixel position, ending horizontal pixel position, starting vertical pixel position, and ending vertical pixel position. These pixel positions are derived from the data accessed in step 1017. Second, tlabel is the text stored in the diagram parameter text file as the label of the item(s) involved in the transaction which, in accordance with this step, will move along the theoretical line of the transaction. Third, the margins are set so as to produce a label within close proximity of the associated shape. Fourth, the Duration command sets the time of 3 seconds over which the animation for each transaction takes place. Fifth, in setting the path over which the transaction moves, the starting point is at the position of the shape representing the transaction, signified by thorizb, and tvertb, the meaning of which are previously discussed.

Upon completion of step 1019 for each transaction, the process has completed the creation of all of the animated transactions and proceeds to step 1027.

If the result of the inquiry of step 1015 is that the print/animate toggle is set to print, the process proceeds to steps 1021 through 1025. The first such step in this series, step 1021, accesses a line of data about a transaction component from the diagram parameter text file—i.e., the following is accessed: transaction number, type, label, starting and ending horizontal pixel positions and starting and ending vertical pixel positions. Some of these values may be blank or meaningless. For example, as more fully discussed below, for the line of data indicating the end of transaction components, the process will only act on one value of the seven accessed—the process will act on the label value ignoring the others. The values acted on are discussed more fully below.

The next step, step 1023, inquires whether there are more transaction components to place in the display. Unlike the situation where the print/animate toggle is set to animate, where each transaction has one line of data for each transaction, when this toggle is set to print, each transaction has several lines of data, one for each component. More particularly, each line that is part of a printed transaction display as well as any label, constitute a distinct transaction component and would therefore have a separate line of data. A transfer, for example, could have 4 transaction components, one for the main line of the transfer, two for the arrow head, and one for a label indicating what is being transferred. Or, a transfer could have more or less than this number of components. Similar logic applies to the other types of transactions. The data that reflects these varying number of transaction components is that stored in the diagram parameter text file. For printed transactions, this file contains a line of data for each transaction component and when all transaction components for all transactions are thus stored in the diagram parameter text file, a final line of data is included in which the label is simply, “PrintEnd”. This is a flag which step 1023 interprets as indicating that the diagram parameter text file contains no more lines of data for transaction components for any transactions. Thus, if step 1023 does not find the flag, step 1023 answers in the affirmative the question of whether more transaction components remain to be processed. If, alternatively, the flag does exist in the line of data, the query of whether more transaction components exist is answered in the negative.

In the instance where step 1023 finds that more transaction components remain to be placed, the process continues to step 1025. Step 1025 places each transaction component into the display. This process can be best understood as accomplishing one (and only one) of two functions: 1) placing a line, either solid or of symbols, or 2) placing a label, into the display. If the data for the present component, accessed in step 1021, does not contain a label, the process performs the function of placing a line. If the data for the present component contains a label, the process performs the function of placing a label.

If the process places a line in step 1025, that line might be solid or might be a theoretical line along which symbols are placed. That line (solid or theoretical) will be placed in the display according to the beginning and ending horizontal and vertical pixel positions accessed in step 1021. If the line is to represent a transfer (or part of a transfer), one of two lines signifying a merger (or part of a merger), or the lines of an arrow head at the end of a line of transfer or a merger, then the process places a solid line. If the line represents a liquidation, the line is theoretical and, in the present embodiment, the process places small (8 pixels wide) circles along the theoretical line (see FIG. 22, discussed infra, for an example of a printed liquidation). If the line represents a cancellation, the line is theoretical and, in the present embodiment, the process places small (12 pixels wide) No Symbols (i.e., circles with slashes through them) along the theoretical line. The process determines what a line represents by reference to the transaction type data accessed in step 1021.

In the preferred embodiment, the process uses the transaction number data accessed in step 1021 to further differentiate the placement of transaction components. The preferred embodiment gives each transaction (i.e., all components represented by the same transaction number) a different color. In other embodiments, the process would place a number next to each separate transaction. In yet further embodiments, the size or type of line is varied or the symbol for liquidations or cancellations is varied. It should be understood that the process could utilize these as well as any other available manner of differentiating displays, alone or in combination.

Having thus placed a transaction component into the display, the process loops back to step 1021 to access the data for the next transaction component. As previously disclosed, the loop continues until the process encounters the flag signifying that all components of all transactions have been placed into the display.

Having placed the transactions into the display, the process then accesses and places any quotes into the display. First, the process accesses the quote label and starting vertical pixel position, if any, step 1027. The process in step 1029 then places the quote so accessed into the display with the top line of such quote being placed at the position indicated by the starting vertical pixel position so accessed. Subsequent lines of the quote are placed sequentially below in the display.

The process then accesses the title, if any, step 1031, and places that title into the display, step 1033. As discussed above, the preferred embodiment places the title, if any, at the top of the display, in the first 50 pixels of the display.

The process concludes placement for this particular display by accessing and displaying each owner attribute for this display. The process accesses for each owner attribute, the label, and starting horizontal and vertical pixel position, step 1035. The process in step 1037 then places the label so accessed starting at the pixel position indicated from the data accessed. The process performs this function of accessing, step 1035, and placing, step 1037, owner attributes for the number of times indicated by the count of owner attributes, a number accessed in step 1005.

Having placed all items to be displayed in the display, the process has completed the display for this diagram. The process then loops back to step 1003 to determine whether more diagrams remain to be created. If not, the process described in FIG. 10 and step 107 is complete, and the result is a computer file containing the displays of diagrams so created. In the preferred embodiment, this file is a Microsoft PowerPoint file.

Finally, the process presents the result of the processing, step 109. In the preferred embodiment, the user would access the PowerPoint file created in step 107 and sequentially view the display for each diagram in a manner consistent with viewing PowerPoint slides.

While the description of the present embodiment does not include the possibility of including a footer (i.e., information displayed at the bottom of a diagram) such a possibility could be useful in certain circumstances. This footer could include, for example, a copyright notice. The user could provide for such a footer through an appropriate phrase, such as, “footer Copyright 2005 Amalgamated American Tax”, placed into the diagram description text file. This flag could be interpreted as being universal in one embodiment, while unique to the particular diagram in another embodiment. In the preferred embodiment different flags could be used for universal and separate footers.

The treatment of these footers would be largely comparable to the treatment of “Title”. For example, any phrase starting with the word “Footer” or “footer” would be processed as a whole—i.e., if a phrase starts with the word, “Footer” or “footer”, all text in the phrase that follows such word could be stored as the value for the footer, and output to the diagram parameter text file as the value of footer. The process could then place such label at or near the bottom of the diagram (e.g., starting at vertical pixel position 450) in the diagram presentation file.

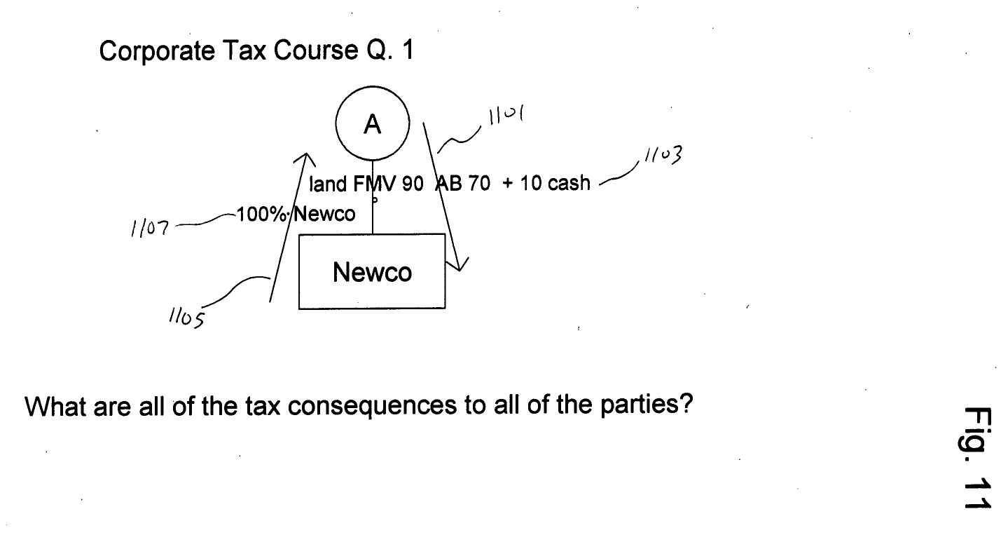

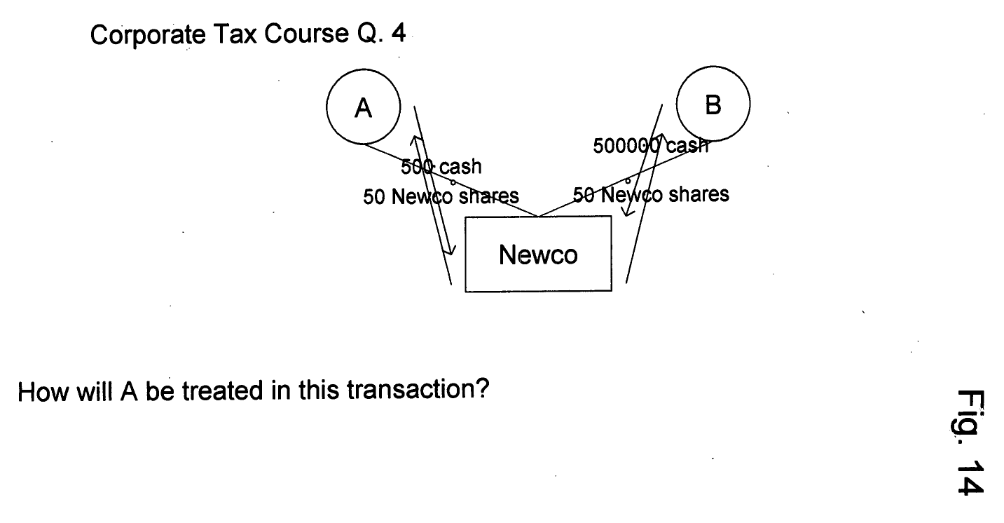

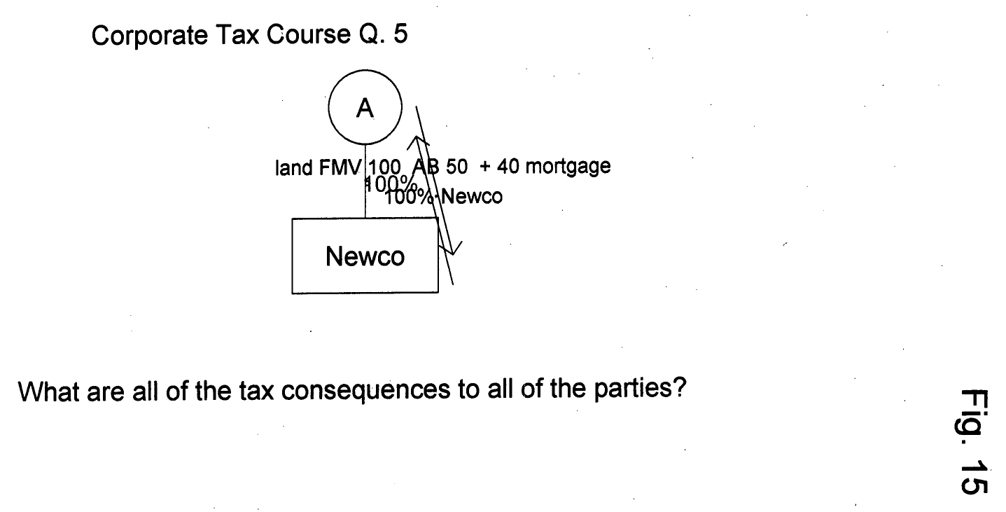

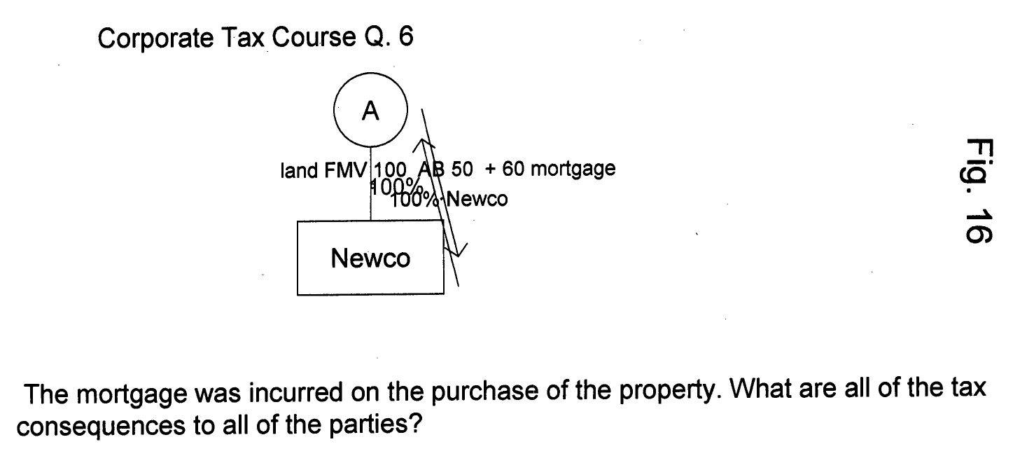

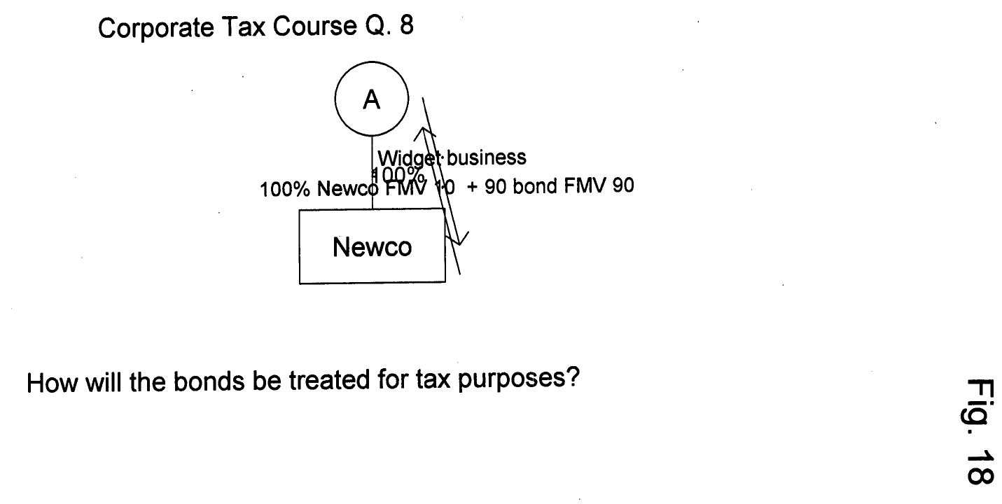

FIGS. 11 through 18 are printouts of slides actually produced by the present embodiment. More particularly, FIGS. 11, 12, 13, 14, 15, 16, 17, and 18 are the printouts of slides that result from diagram description text file, FIG. 3, descriptions 301, 303, 305, 307, 309, 311, 313, and 315, respectively, which in turn were produced from FIG. 2, scenarios 201, 203, 205, 207, 209, 211, 213, and 215, respectively.

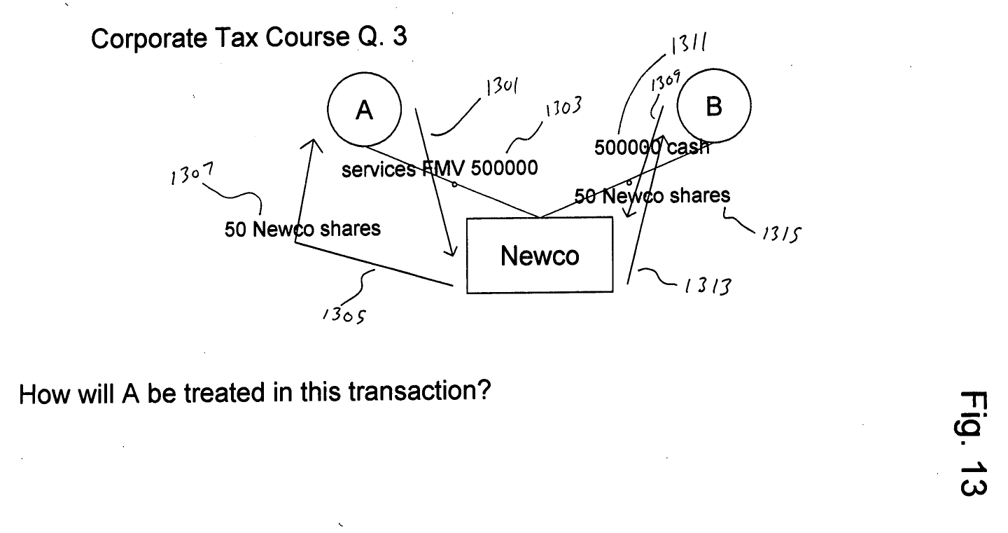

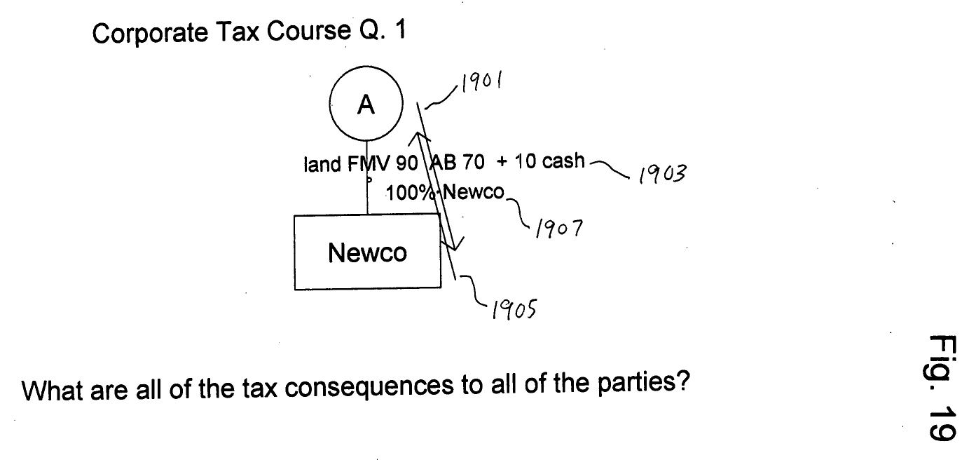

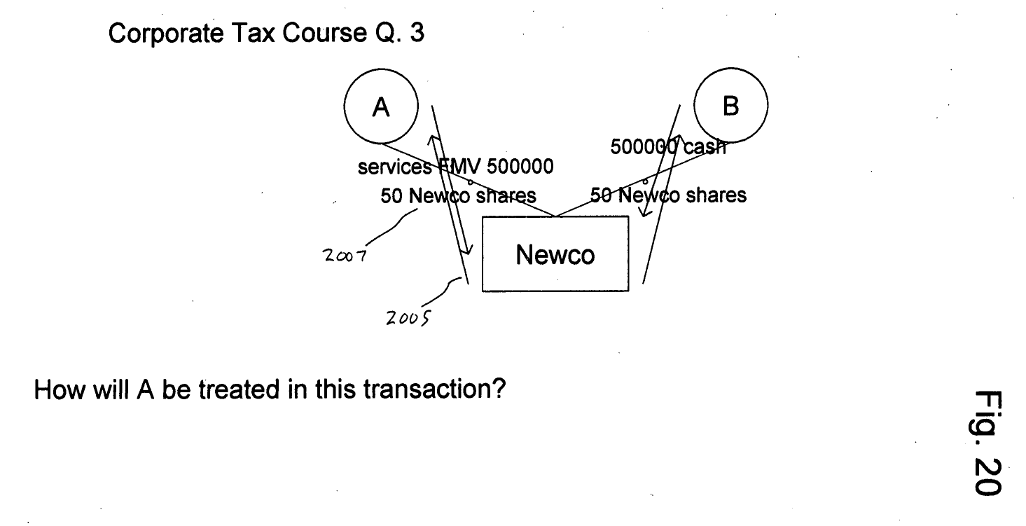

Upon observation of these printouts, the reader will note that even using the default process described previously, the printouts may cause minor confusion about the content being displayed. It should first be noted that this confusion would be far less of an issue when transactions are animated. Secondly, the confusion can be largely eliminated by use of the invention's user-selectable parameters to move placement of transactions. This point can be illustrated by reference to FIGS. 11, 13, 19, and 20. In FIG. 11, two transfers are illustrated: a transfer from A to Newco and a transfer from Newco to A. The transfer from A to Newco is illustrated with arrow 1101 and label 1103. The transfer from Newco to A is illustrated with arrow 1105 and label 1107. Arrow 1105 and label 1107 are to the left of the parties A and Newco, and, in general, the placement of the arrow and label are such as to cause little confusion with the other transaction displayed to the right of the parties A and Newco. FIG. 11 should be contrasted with FIG. 19. FIG. 19 illustrates the same basic transaction, with a transfer from A to Newco and another transfer from Newco to A. In FIG. 19, however, arrow 1901 for the first transfer is closely alongside arrow 1905 for the second transfer. Likewise, label 1903 for the first transfer is closely above label 1907 for the second transfer. Perhaps more importantly, it may not be clear in FIG. 19 which label is associated with which transfer (arrow). By placing one transfer on either side of the parties, FIG. 11 avoids this problem. The user accomplishes this adjustment by employing the variables EX and BX, as are apparent in the fourth line of description 301, the further description of which has been previously indicated. A BX value of −130 adjusts the arrow by starting the arrow 130 pixels to the left of the point where the arrow would start by default (i.e., the point automatically produced without adjustment). An EX value of −80 ends that arrow 80 pixels to the left of the point where the arrow would end by default. Note that because the starting and ending adjustments are different, the slope of the arrow changes, as is apparent when contrasting FIGS. 11 and 19. In a somewhat similar fashion, a comparison between FIGS. 13 and 20 highlights the advantage of using further user-selectable variables of the invention, variables MY and MX. FIG. 13 illustrates the use of these variables while FIG. 20 illustrates the transaction without use of the variables. FIG. 13 illustrates a transaction in which 4 transfers occur. The first is a transfer from A to Newco, represented in the diagram as arrow 1301 and label 1303. The second is a transfer from Newco to A, represented in the diagram as arrow 1305 and label 1307. The third is a transfer from B to Newco, represented in the diagram as arrow 1309 and label 1311. The fourth is a transfer from Newco to B, represented in the diagram as arrow 1313 and label 1315. The particular focus of the comparison between FIGS. 13 and 20 involves the second transfer, i.e., the transfer from Newco to A as represented in the diagram with arrow 1305 and label 1307. FIG. 20 contains the same 4 transfers. This second transfer, from Newco to A, is represented in the diagram in FIG. 20 as arrow 2005 and label 2007. As can be observed, FIG. 20 produces by default (i.e., as produced automatically before use of the user-selectable adjustment variables of the invention) a printed diagram with 4 transfers where each of the transfers is displayed so close to another transfer as to be potentially confusing to the reader. In FIG. 13, the transfer from Newco to A has been adjusted from its default in order to remove the confusion between that transaction and the first transfer from A to Newco, as represented by arrow 1301 and label 1303. In this instance, as indicated by the third line of description 305 from FIG. 3 (i.e., line 405 from FIG. 4), the adjustment uses 3 of the user-selectable variables of the invention, MY, MX, and EX Consistent with the previous description with reference to step 613, the variables MY and MX allow the user to have the process produce a printed display where the transfer would occur not over a straight line but over a line angled at it's middle. Where the user utilizes the MX and/or the MY variables, the start and end of the line is at the default start and end (unless these too are modified) but where the line is a not a direct connection between these two points but is instead connected to a point that is the default midpoint of the line moved horizontally by the number of pixels (positive or negative) designated by the value of MX and moved vertically by the number of pixels (positive or negative) designated by the value of MY. Because the midpoint of the line is adjusted while the start and end are not (or need not be) adjusted, the line of the transfer will have an angle.

The present embodiment allows for the simultaneous use of MY and MX variables with the BX, BY, EX, and EY variables. The present embodiment applies the simultaneous use of such variables by first adjusting the starting and ending points of the line consistent with the values indicated by BX, BY, EX, and EY, then adjusting the midpoint consistent with the values MY and MX. The third line of description 305 (line 405) provides the following user-selectable variables and values: MY, 20; MX, −60; EX −70. These adjustments contribute to the production of the arrow 1305 in FIG. 13. This arrow 1305 should be contrasted with arrow 2005 in FIG. 20, which is the arrow produced by the process by default (i.e., without use of user-selectable variables). The process first applies the variable EX with the result that the end of the line produced by default is moved to the left by 70 pixels. Thus, instead of the arrow head of this transfer being to the right of A, the arrow head is to the left. The arrow 1305 has the same starting horizontal and vertical and ending vertical pixel positions as arrow 2005 because these variables were not adjusted. The process then applies the variables MY and MX. The midpoint of the line of the transfer is shifted 20 pixels down and 60 pixels to the left, thus producing the angle present in arrow 1305. The label 1307 is likewise shifted consistent with the new midpoint. As a result, the information intended to be conveyed as relates to transfers between A and Newco is more readily discernible.

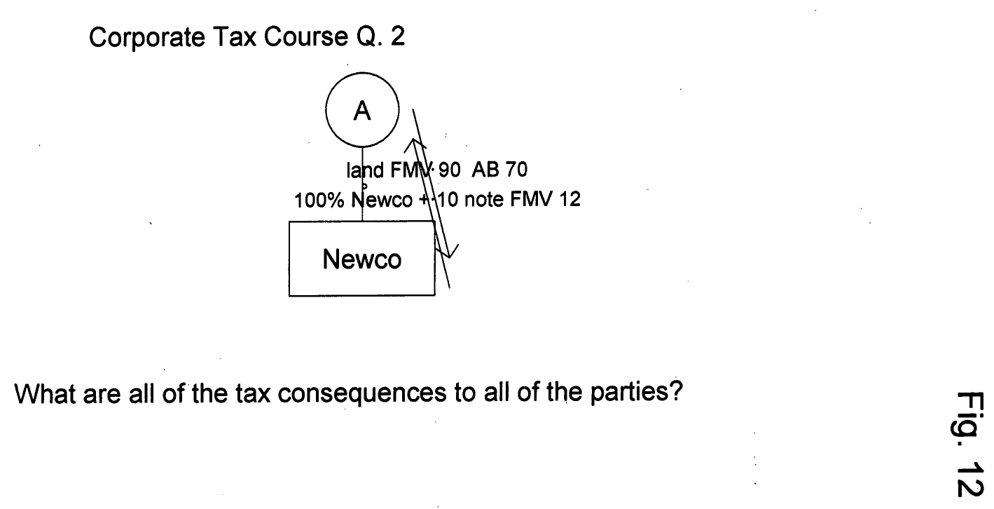

It should be noted that the printouts of slides illustrated in FIGS. 12 through 20 have not been optimally adjusted, or completely optimally adjusted, employing these user-selectable variables. As can be observed, for example, from FIG. 13 and FIG. 20, the transactions between B and Newco have the same issues of possible confusion to the reader as do the transactions between A and Newco. And thus, even for the printout illustrated in FIG. 13, additional use of these variables would produce a printout that is more readily understood, further highlighting the advantage provided by the invention's inclusion of these variables.

The description above by reference to FIGS. 1 through 20 discloses the core of the present invention. It should be understood that the invention comprehends other aspects as well.

One such aspect entails use of speech-to-text recognition. This capability is available within Microsoft Office, an application that includes Microsoft PowerPoint. This capability is also provided by other engines including those available for the Microsoft Windows environment. This functionality can be particularly useful in a teaching environment. In such an environment, a teacher or other presenter can create animated or printed diagrams on a spontaneous basis in order to illustrate points that, for whatever reason, were not prepared beforehand.

Another aspect utilizes the functionality of text-to-speech. The invention can use this functionality to good effect in the process of displaying diagrams. In one such use, as animated diagrams are being displayed, a text-to-speech functionality would, using for example the same text used to create the diagram or parts of the diagram (e.g., the text describing transactions), convert that text to speech and output that speech simultaneously with components being added to the diagram or with transactions being animated. Of course, the user could alternatively incorporate audio descriptions with the diagrams being displayed.

In the preferred embodiment, English is used as the language for labels, quotes, titles and other textual information displayed. In other embodiments, other languages are used. In one such embodiment, the person desiring to create the diagrams is given a choice of language to use. In some such embodiments, Unicode files are used in place of text files.

In one such embodiment, the person desiring to create the diagrams can place into a diagram description Unicode file (a file essentially equivalent to a diagram description text file except Unicode is used) a flag indicating the desired language to be displayed in the diagram. The process of the invention would lookup in a table those words with a cross-reference to the equivalent English word and would place that foreign-language word in the label output to the diagram parameter Unicode file (a file essentially equivalent to a diagram parameter Unicode file except that Unicode is used). For example, the foreign language equivalent of FMV, AB, shares, cash, land, debt, bonds, notes, liabilities, services, earnings and profits, etc. could be provided in such a lookup table. For those words not referenced in the lookup table, the process would seek a translation through commonly available electronic cross-language dictionaries, or if appropriately flagged by the person desiring to create the diagrams, no translation would occur for the flagged word or words. If desired, numbers could likewise be translated. The appropriately translated words and numbers would then be accessed by the process to create a diagram presentation file with those translations.

While the core functionality of the invention does not require the use of extensible markup language (XML) or any other markup language, the use of such a markup language could enhance the functionality of the invention. The facts that form the basis of diagrams could be input in the form of XML. Or, the facts could be formatted consistent with the prior description of diagram description text files and those facts could then be converted into XML or another markup language so that all or many such diagram descriptions could share known common features. Thus, if a collection of many (e.g., hundreds or thousands) of diagrams were created, having these diagrams in the form of XML would allow for a database of such diagrams where diagrams sharing a common feature could be easily isolated and possibly manipulated. If, for example, a statute were passed that withdrew reorganization status for mergers, the creator of a voluminous series of diagrams could more easily isolate and reconsider those transactions that involve mergers. The use of XML to identify common features between diagrams could also be used to good effect to later apply artificial intelligence techniques (e.g., an expert system) to such transaction descriptions.

To this point, the invention has been described such that, up through the point of the diagram being displayed, the diagram in its various phases (diagram description text file, diagram parameter text file and diagram presentation file) is entirely electronic. While this approach has substantial value by itself, the invention allows for other manners of delivering the diagrams. While the tax practice heavily utilizes personal computers and other electronic devices, the tax practice also heavily utilizes printed books, periodicals and other hardcopy media. In a context where the concepts being conveyed can be extremely complicated, some practitioners may find relying entirely on the computer to read complex provisions as unacceptable. An issue therefore arises—how does one convey information through a paper medium and also convey the benefits offered by the present invention. One possibility has already been described—the diagrams are created with the intention of having the diagrams printed, the diagrams are indeed created and printed, and those printed diagrams are indeed then printed and integrated with the other printed information being conveyed. Thus for example, a book could contain all of the text of Subchapter C of Chapter 1 of Subtitle 1 of the Internal Revenue Code, as well as printed diagrams illustrating various rules contained in that Subchapter C. Many practitioners may find this approach extremely useful, and yet, other practitioners may find this approach less than ideal. Certainly, this approach would not allow for diagrams with animation. Another approach that would allow for animation would include separate but parallel conveyances of information. In one such instance, a printed book could contain the textual information being conveyed while referencing through a textual message the existence of a diagram in electronic form in software on the computer. As a reader of the book comes upon a passage the meaning of which can be better explained through a diagram, where that passage has alongside it an icon or other visible signal signifying that a diagram is available, the user could turn to the computer, locate the appropriate diagram and then display that diagram, including an animated version of the diagram. Again, this approach would be viewed as a substantial improvement over what presently exists to convey this complicated information. And yet, while a substantial improvement, even this approach might be met by some practitioners as less than ideal. Such an approach would require the user to perform several steps to go from the printed information to the diagram.

To address these concerns, the invention also includes heretofore unused techniques to facilitate the transition between paper and electronic. The invention allows for the use of both human readable and machine readable data on the printed page. In summary, and as more fully described below, these data are then imaged by an electronic device so that a signal is produced, which such signal causes the same or different electronic device to display a diagram or diagrams. This printed data can be placed onto essentially any printed media, including those commonly used in the tax practice Such possibilities can include printed Internal Revenue Codes, Income Tax Regulations, Internal Revenue Bulletins, treatises, handbooks, compendiums, periodicals, updates, training materials, etc.

It should be understood that data that is human readable could also be comprehended by machine. Thus, for example, through the use of optical character recognition (OCR) or printed icons that convey messages to both humans and machines, signals could be conveyed to an electronic device without the need, partially or entirely, for printed data that is just machine readable. In one such instance, for example, a particular Internal Revenue Code section citation might be printed with a particular font. Because the text is printed, it could be read by machine with low incidence of error. Because the text is of a particular font, the electronic device could understand that this particular text (in distinction to all of the other printed text) acts as a signal to display a diagram or diagrams. That same text could and would be read by the human reader, indicating that there is a diagram or diagrams associated with this particular section.

For various reasons, the data to be understood by machine is typically best conveyed by digital means that would not be understood by humans. The reasons include lower incidence of error, error detection, error correction as well as the ability to convey significantly more and more varied data than would be possible with human readable information. The machine readable information may be through the use of barcodes or other symbologies that encode digital data on paper. One such symbology is disclosed in U.S. Pat. Nos. 6,098,882, 6,176,427 and 6,820,807. This is the preferred symbology for the present invention. These symbols are printed on the page along with human readable information In some embodiments, the digital data is printed with visible ink while in other embodiments, the digital data is printed with invisible (e.g., infrared or ultraviolet) ink. Visible ink provides a visual symbol of the existence of digital data and can readily imaged by a wider population of devices while invisible ink can be placed on top of other printed information, thus occupying no additional space, and is less obtrusive visually. The choice is left to the user to be decided based on the circumstances. In most instances, visible ink is preferable.

There exists a number of possibilities as to what data is placed in the machine readable code, including the following:

1. “license plate” data—i.e., a serial number or other brief identifying signal

2. Internal Revenue Code section citation or comparable reference

3. a passage or passages from the diagram description text file

4. a passage or passages from the diagram parameter text file

5. a PowerPoint file

6. an image file of a diagram or diagrams

7. an animation file of a diagram or diagrams

The creator of a diagram or series of diagrams can select which of these possibilities to proceed with based on the existing circumstances. Use of “license plate” data would typically require placement of the least amount of digital data within the machine readable code, but would typically require the placement of the greatest amount of data onto the device that would decode and display the diagram, and would require additional programming to match up the serial number or other identifying signal to a particular diagram or diagrams. Placement of an Internal Revenue Code section citation or comparable reference in the digital data will typically require somewhat more digital data but less programming on the decoding/displaying device. The decoding/displaying device would still have to contain the diagram or diagrams or the ability to create the diagram or diagrams and further data, such as the related passage or passages from the diagram description or parameter text files. A comparable reference could include, for example, the name and location (on the decoding/displaying device or elsewhere, such as a URL to a location on the Internet or other network) of a file containing the diagram or diagrams. Placement of a passage from the diagram description text file would typically require placement of still further amounts of digital data in the machine readable code, but this could typically be all the diagram-specific data needed to create a diagram. As such, the decoding/displaying device would typically require the algorithms to (in addition to capturing an image of the machine readable code and converting that image to digital data) convert the passage or passages from the diagram description text file into a diagram parameter text file and then convert that file into a diagram, static or animated, and then display that diagram together with any animation and/or audio. As previously noted, the steps of creating a diagram parameter text file and then a diagram presentation file could and likely should be collapsed into one step—i.e., parameters would be determined and diagrams created without the intermediary step of creating a diagram parameter text file. Because this could typically be the only software required to be stored in the decoding/displaying device, the software on such device could be quite flexible in its handling of a variety of diagrams, including newly created diagrams, such as might be created as a result of changes to the tax law. A similar flexibility could be achieved by placing a passage or passages from the diagram parameter text file into the printed digital data. Such a passage or passages would have the added advantage of requiring less software to be stored on the decoding/displaying device. A disadvantage relative to the previous option is that passages from a diagram parameter text would typically be somewhat larger than comparable passages from a diagram description text file. There may be other relative disadvantages as well. For example, different decoding/displaying devices may require different parameters and thus one passage may not afford the same universal usage. As a further possibility, the creator could place a PowerPoint file into the printed digital data. This possibility would have the considerable advantage of requiring less computation on the decoding/displaying device, as well as requiring no special software on the decoding/displaying device other than the ability to decode the printed digital data and the PowerPoint application itself Typically, the amount of digital data required within the printed symbol would be much larger than is true with the previous possibilities. Also, this possibility would limit the display to those devices capable of running PowerPoint. This limitation can be overcome by the last two possibilities—placing within the printed digital data an image file (for static displays) or an animation file (for animated displays). These possibilities would present varying degrees of compatibility across decoding/displaying devices as well as varying degrees of requisite advanced placement of software across devices depending on how the displays are created.

It should be noted that each of the above possibilities, but particularly options 3 through 7, could also include audio narrations. Of course, the addition of audio could significantly increase the amount of digital data required to be placed within the printed symbol.

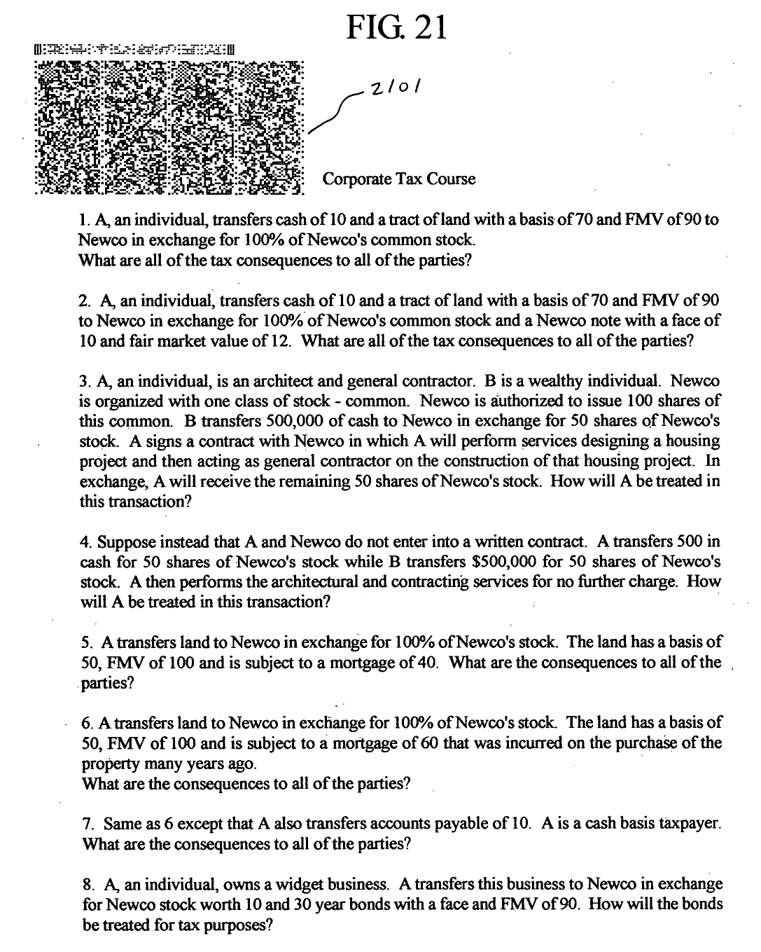

Of the various possibilities available, the preferred method would place a passage or passages from a diagram description text file into the printed digital data (i.e., possibility number 3 from the list above). This digital data would preferably not include audio so as to minimize the amount of digital data. FIG. 21 illustrates an example of this possibility. FIG. 21 contains the same textual information as FIG. 2, which as previously discussed could be a handout distributed to students of a corporate taxation course. This figure also contains machine readable code 2101, which such code contains the diagram description text file of the scenarios printed (i.e., printed for human reading) in FIG. 21.

The use of machine readable code could be used to good effect for presenting to users the choice of viewing printed as well as animated diagrams produced by the invention. In one such embodiment, a printed diagram produced by the invention would also contain machine readable code containing the diagram description text file that produced the diagram itself (except that the diagram description text file in the machine readable code would not contain the flag, “Printout” or “printout”, which sets the print/animate toggle to print). FIG. 22 represents a slide produced by such an embodiment. This slide contains a diagram produced by the invention, and it also contains machine readable code 2201 where that machine readable code contains a diagram description text file for the diagram in the slide itself (exclusive of the print flag). By imaging, decoding and launching the associated software, a decoding/displaying device could thusly provide an animated version of the diagram. This slide also illustrates the preferred manner of illustrating mergers and liquidations in printed slides. Transaction 2202 illustrates a merger, while transaction 2203 illustrates a liquidation.

Once the transaction data is placed onto the paper, the user must have some means of decoding and then displaying that data. One such possibility is that the user implements the combination of a flatbed scanner and personal computer. Such methods of deriving data, including both human readable (through use of, e.g., OCR) and digital data are well known. While such possibilities will be of use in some circumstances, under many circumstances such possibilities could prove overly cumbersome and time consuming relative to entirely electronic delivery of tax materials together with associated diagrams. The techniques described above could therefore be well used through the use of other delivery vehicles. One such possibility would allow the use of a personal digital assistant. Such a PDA would include an attached imager such as a digital camera and, depending on the possibility of which digital data is printed, requisite software. Another possibility would allow the use of a phone, such as a cellphone or smartphone such as one that would use the Microsoft SmartPhone operating system (e.g, the Mitac Mio 8380) or its successors. A still further possibility would allow the use of a combination of a personal computer and a webcam as the imager. With this combination, it could, for example, be possible for a printed page to have machine readable code that contains several passages and when the combination personal computer/webcam/associated software identifies the machine readable code, the combined device would decode the digital data, present to the user a choice of which diagram to display from the options presented in the digital data just decoded and then launch (if not previously launched) the displaying software together with the diagram selected for display by the user. Alternatively, if the machine readable code contains data relating to a single diagram, the combination personal computer/webcam/associated software could, upon recognizing that machine readable code, automatically image and decode that code, and then launch (if not previously launched) the displaying software together with that single diagram. Likewise, such a combination could automatically launch a series of diagrams upon recognizing an appropriate machine readable code. It should of course be understood that other devices or combinations of devices could be used to equally good or better effect.

1. A method of authoring transactions for display comprising:
inputting text describing at least one transaction, and
converting said text into diagrams to be displayed.

2. The method of authoring of claim 1 wherein the text describing at least one transaction describes a rule of tax law.

3. The method of authoring of claim 1 where the text describing at least one transaction describes an example of a tax law principle.

4. The method of authoring of claim 1 where the text describing at least one transaction describes a business transaction

5. The method of authoring of claim 4 where the transaction is a transaction being considered.

6. The method of authoring of claim 4 where the transaction is a transaction at least partially completed.

7. A method of displaying a transaction comprising:
display of a plurality of parties, and
display of at least one action between at least two parties where the display of that at least one action is a moving display.

8. The method of displaying of claim 7 where the transaction illustrates a rule of tax law.

9. The method of displaying of claim 7 where the transaction illustrates an example of a tax law principle.

10. The method of displaying of claim 7 where the transaction illustrates a business transaction.

11. The method of displaying of claim 10 where the transaction is a transaction being considered.

12. The method of displaying of claim 10 where the transaction is a transaction at least partially completed.

13. The method of displaying of claim 7 where the movement is in the direction in the display between one party performing the action and the other party receiving the action.

14. The method of displaying of claim 7 where the moving display is contained in an animation file.

15. The method of displaying of claim 14 where the animation file further comprises audio.

16. A method of determining the placement of persons in a diagram comprising:
inputting text describing at least one ownership of at least one of debt or equity between at least two persons, and
converting that text into data describing the placement of said at least two persons in said diagram.

17. The method of claim 16 wherein the converting of text into data describing the placement of said at least two persons in said diagram comprises:
determining distinct chains of ownership of at least one of debt or equity, and determining placement of persons within a chain based on the ownership relationship between the at least two persons described in the text inputted.

18. The method of claim 17 wherein determining placement of persons within a chain based on the ownership relationship comprises an iterative process of determining placement of persons within a chain based on ownership relationships.
